(19) United States
(12) Patent Application Publication
(10) Pub. No.: US 2012/0037616 A1
(43) Pub. Date: Feb. 16, 2012

(54) POWER INVERTER

(75) Inventors: Tadayuki Kitahara, Tokyo (JP); Shiro Fukuda, Tokyo (JP); Ryuichi Shimada, Tokyo (JP); Takanori Isobe, Tokyo (JP)

(73) Assignee: MERSTech INC., Tokyo (JP)

(21) Appl. No.: 13/062,513

(22) PCT Filed: Oct. 27, 2009
(86) PCT No.: PCT/JP2009/068440

§ 371 Date: May 27, 2011

Related U.S. Application Data
(60) Provisional application No. 61/160,315, filed on Mar. 15, 2009.

(30) Foreign Application Priority Data
Oct. 27, 2008 (JP) PCT/JP2008/069784

(51) Int. Cl. H05B 6/04; H02P 23/00; H05B 6/06; H02M 7/5387

(52) U.S. Cl. 219/665; 363/132; 318/494

(57) ABSTRACT

A power inverter (1) is provided with a full-bridge circuit (10), a shunt capacitor (CP), and a control circuit (20). The control circuit (20) controls the on/off state of each reverse-conductive semiconductor switch (SW1 to SW4) at a switching frequency of not more than the resonance frequency determined by the capacitance of the shunt capacitor (CP) and the inductance of an inductive load (LD) in such a matter than when a first reverse-conductive semiconductor switch (SW1) and a fourth reverse-conductive semiconductor switch (SW4) are in the on-state, a second reverse-conductive semiconductor switch (SW2) and a third reverse-conductive semiconductor switch (SW3) are brought into the off-state, and that when the first reverse-conductive semiconductor switch (SW1) and the fourth reverse-conductive semiconductor switch (SW4) are in the off-state, the second reverse-conductive semiconductor switch (SW2) and the third reverse-conductive semiconductor switch (SW3) are brought into the on-state.

### TECHNICAL FIELD

The present invention relates to a power inverter for converting direct-current power into alternating-current power, and more particularly to a power inverter that has the function of amplifying resonant current.

### BACKGROUND ART

Power systems have been standardized and become social infrastructure that can be used regardless of time or location. However, freedom to control load is limited when using this standardized power without modification. Consequently, power converters are needed in order to convert power obtained from the power system and freely control load.

Power converters generally consist of power rectifiers for converting alternating-current power into direct-current power, and power inverters for converting direct-current power into alternating-current power.

In general, a power rectifier rectifies alternating-current power, converts it into direct-current power and stores this in a capacitor of sufficiently large capacity. In contrast, a power inverter converts direct-current power stored in a capacitor into alternating-current power through switching, and supplies this to the load. In this structure, in general it is impossible through hard switching to avoid the generation of surge voltage, the creation of high-harmonic noise, and the generation of heat caused by power loss in the semiconductor device used for switching. In order to avoid these problems, a current resonant inverter is also used that causes the capacitor and inductor to resonate, switches circuits with a timing such that the charge stored in the capacitor is roughly zero, in other words the voltage at both ends of the capacitor is roughly zero (V), and thereby creates alternating-current power.

In particular, current resonant inverters are widely used in inductive heat power supplies, which are an ideal application example when handling large amounts of power with a power inverter, because the inductive coil for heating the object being heated through magnetic inductance becomes an inductive load and in addition a large current flows through the inductive coil.

However, in inductive heat power supplies using current resonant inverters, in general the resonant inductive coil and the capacitor used for resonance (hereafter called the resonant capacitor) are not variable, so the resonant frequency is fixed and it is difficult to change the frequency of the alternating-current power supplied to the inductive coil. A power inverter is sought which is of current resonant type and which can change the frequency of alternating-current power supplied to inductive coils.

A power inverter satisfying the above requirement has already been filed and disclosed and is commonly known (see Patent Literature 1). The power inverter disclosed in Patent Literature 1 is composed of a circuit in which four semiconductor switches have a full-bridge connection, a resonant capacitor in which magnetic energy having an electric current connected between the direct current terminals of the full-bridge circuit is accumulated as a charge and which is regenerated by discharging this charge, and an inductive load connected between the alternating-current terminals of the full-bridge circuit. The semiconductor switches use circuits combining semiconductor devices having a forward blocking ability such that on and off can be controlled by signals provided from the outside, and semiconductor devices having the capacity to normally pass electric current in the forward direction while inhibiting electric current in the reverse direction, that is to say which has a rectifying action, or use semiconductor devices having capacity equivalent to such combination circuits. For example, this may be a circuit in which a switching transistor and diode are connected in parallel so that the forward directions are opposite each other, or a Metal-Oxide-Semiconductor Field-Effect Transistor (MOSFET) that includes a parasitic diode. A semiconductor switch having the above characteristics is called a reverse-conductive semiconductor switch and is appropriately used per the following explanation.

More specifically, in the power inverter disclosed in Patent Literature 1, two reverse-conductive semiconductor switches in non-neighboring connection positions out of the four reverse-conductive semiconductor switches in the full-bridge circuit are made pairs and a semiconductor device having a forward blocking ability comprising the reverse-conductive semiconductor switches of one of these pairs is simultaneously turned on and off (hereafter referred to as switching) while the semiconductor device having a forward blocking ability comprising the reverse-conductive semiconductor switches of the other pair is switched with a timing that is in reverse phase to the timing of the on/off switching applied to the first pair. In addition, the time ratio for holding the on state and the off state is equal.

By setting the switching frequency at no more than the resonant frequency determined by the electrostatic capacitance of the resonant capacitor and the inductance of the inductive load, when the semiconductor device having a forward blocking ability comprising reverse-conductive semiconductor switches is in a passing state (hereafter referred to as “on”), the voltage impressed on the semiconductor device having a forward blocking ability comprising reverse-conductive semiconductor switches is approximately 0 [V] and electric current flows through the semiconductor device having a rectifying action. In addition, when the semiconductor device having a forward blocking ability comprising reverse-conductive semiconductor switches is in a blocking state (hereafter referred of as “off”), the voltage impressed on the semiconductor device having a forward blocking ability comprising reverse-conductive semiconductor switches is approximately 0 [V], so that so-called soft switching is realized.

In addition, by controlling operation at a switching frequency that is no more than the resonant frequency, it is possible to make the resonant capacitor function as a variable capacitor. That is to say, it is possible to supply alternating-current power of variable frequency to the inductive load. The power inverter disclosed in Patent Literature 1 has the characteristic of being a current resonant type and also realizing variability in the frequency of the alternating-current power supplied to the inductive load.

### PRIOR ART LITERATURE

### Patent Literature

Patent Literature 1: International Publication No. WO2008/096664

### SUMMARY OF INVENTION

### Problem Solved by the Invention

In the power inverter disclosed in Patent Literature 1, when the resonant capacitor charges or discharges in resonance with the inductance of the inductive load, all electric current of the circuit flows to at least one out of the four reverse-conductive semiconductor switches comprising the full-bridge circuit. When the power inverter disclosed in Patent Literature 1 is used as a power supply requiring large power such as a power supply for inductive heating, a large electric current flows through the reverse-conductive semiconductor switches. Consequently, the conduction loss in the reverse-conductive semiconductor switches becomes large, creating the problem that the advantages of low loss and low heat generation that are the characteristics of soft switching are diminished.

In consideration of the foregoing, it is an object of the present invention to provide a power inverter in which the electric current that flows through the reverse-conductive semiconductor switches is relatively small. In addition, it is an object of the present invention to provide a power inverter equipped with a soft switching function and in which the electric current that flows through the reverse-conductive semiconductor switches is relatively small.

### Problem Resolution Means

The power inverter according to the present invention provides a power inverter, having as an reverse-conductive semiconductor switch a circuit in which a self-extinguishing device that can switch between a conductive state and a blocked state of the device through signals obtained from outside, and a device having a rectifying action, are connected with forward directions mutually inverted from each other, or a semiconductor equivalent to this circuit,

provided with a full-bridge circuit having a first reverse-conductive semiconductor switch, a second reverse-conductive semiconductor switch the positive pole of which is connected to the negative pole of the first reverse-conductive semiconductor switch, a third reverse-conductive semiconductor switch the positive pole of which is connected to the positive pole of the first reverse-conductive semiconductor switch, a fourth reverse-conductive semiconductor switch the positive pole of which is connected to the negative pole of the third reverse-conductive semiconductor switch and the negative pole of which is connected to the negative pole of the second reverse-conductive semiconductor switch, a first alternating-current output terminal connected to the connection point of the first reverse-conductive semiconductor switch and the second reverse-conductive semiconductor switch, a second alternating-current output terminal connected to the connection point of the third reverse-conductive semiconductor switch and the fourth reverse-conductive semiconductor switch, a positive pole terminal connected to the positive pole of the third reverse-conductive semiconductor switch and the first reverse-conductive semiconductor switch, and a negative pole terminal connected to the negative pole of the second reverse-conductive semiconductor switch and the negative pole of the fourth reverse-conductive semiconductor switch;

a first capacitor connected between the first alternating-current output terminal and the second alternating-current output terminal; and

a control circuit;

wherein a direct-current power supply is connected between the positive pole terminal and the negative pole terminal;

an inductive load is connected between the first alternating-current output terminal and the second alternating-current output terminal;

the control circuit controls the on/off state of the reverse-conductive semiconductor switches so that the second reverse-conductive semiconductor switch and the third reverse-conductive semiconductor switch are brought into an off state when the first reverse-conductive semiconductor switch and the fourth reverse-conductive semiconductor switch are in an on state; and

so that the second reverse-conductive semiconductor switch and the third reverse-conductive semiconductor switch are brought into an on state when the first reverse-conductive semiconductor switch and the fourth reverse-conductive semiconductor switch are in an off state; and

the control circuit further controls the on/off states of the reverse-conductive semiconductor switches at a switching frequency that is no more than the resonant frequency determined by the capacitance of the first capacitor and the inductance of the inductive load.

In addition, the power inverter according to the present invention further comprises a second capacitor connected between the positive pole terminal and the negative pole terminal of the full-bridge circuit;

wherein the control circuit controls the on/off state of the reverse-conductive semiconductor switches at a switching frequency that is no more than the resonant frequency determined by the inductance of the inductive load and the composite capacitance of the capacitance of the first capacitor and the capacitance of the second capacitor.

In addition, in the power inverter according to the present invention, the capacitance of the first capacitor is larger than the capacitance of the second capacitor.

In addition, in the power inverter according to the present invention, the first capacitor is composed of a non-polarized capacitor and the second capacitor is composed of a polarized capacitor.

In addition, in the power inverter according to the present invention, the self-extinguishing device is a transistor, a field effect transistor (FET), an insulated gate bipolar transistor (IGBT), an injection-enhanced gate transistor (IEGT), a gate turn-off thyristor (GTO thyristor), or a gate current turn-off thyristor (GCT thyristor).

In addition, in the power inverter according to the present invention, the reverse-conductive semiconductor switch is a metal oxide semiconductor field effect transistor (MOSFET) with a built-in parasitic diode.

In addition, in the power inverter according to the present invention, when the self-extinguishing device is a field effect transistor (FET) or when the reverse-conductive semiconductor switch is a metal oxide semiconductor field effect transistor (MOSFET) with a built-in parasitic diode, the control circuit accomplishes control so that the self-extinguishing device is brought into a conductive state when the device having a rectifying action is conducting.

In addition, in the power inverter according to the present invention, the direct-current power supply is composed of a direct-current voltage supply and a direct-current reactor connected to the direct-current voltage supply.

In addition, in the power inverter according to the present invention, the direct-current power supply is composed of an alternating-current power supply, a rectifying circuit and an alternating-current reactor connected between the alternating-current power supply and the alternating-current terminal of the rectifying circuit.

In addition, in the power inverter according to the present invention, the direct-current power supply is composed of the alternating-current power supply, a thyristor alternating-current power regulator one end of which is connected to the alternating-current power supply, a high impedance transformer the primary side of which is connected to the other end of the thyristor alternating-current power regulator, and a rectifying circuit the alternating-current terminal of which is connected to the secondary side of the high impedance transformer, wherein the control circuit sends control signals to the thyristor alternating-current power regulator and adjusts the volume of the alternating-current power supplied to the inductive load.

In addition, in the power inverter according to the present invention, wherein one or more parasitic oscillation suppression circuits is connected.

In addition, in the power inverter according to the present invention, a resonant reactor is connected to the primary winding terminal with the inductive load as a current transformer for retrieving the alternating-current power isolated from the secondary winding terminal to the primary winding terminal.

In addition, in the power inverter according to the present invention, the inductive load is composed of an alternating-current electric motor and functions as an alternating-current electric motor control system for accomplishing control of the alternating-current electric motor.

In addition, in the power inverter according to the present invention, the inductive load is composed of an induction heating coil for heating an object through electromagnetic induction, and functions as an induction heating system for accomplishing control of induction heating of the object.

### Effect of the Invention

With the power inverter according to the present invention, the electric current passing through the reverse-conductive semiconductor switches can be made relatively small.

### BRIEF DESCRIPTION OF DRAWINGS

FIG. 1 is a block circuit diagram of a power inverter according to a first embodiment of the present invention.

FIG. 2A is a drawing explaining the action of the power inverter shown in FIG. 1.

FIG. 2B is a drawing explaining the action of the power inverter shown in FIG. 1.

FIG. 2C is a drawing explaining the action of the power inverter shown in FIG. 1.

FIG. 2D is a drawing explaining the action of the power inverter shown in FIG. 1.

FIG. 2E is a drawing explaining the action of the power inverter shown in FIG. 1.

FIG. 2F is a drawing explaining the action of the power inverter shown in FIG. 1.

FIG. 3 shows in parts (1) through (5) waveform diagrams for explaining the action of the power inverter shown in FIG. 1, with (1) showing the waveform of the voltage Vload impressed on the inductive load LD, (2) showing the waveform of the current Iload flowing in the inductive load LD, (3) showing the waveform of the current Isw2 flowing in the reverse-conductive semiconductor switch SW2, (4) showing the waveform of the current Icm flowing in the resonant capacitor CM and (5) showing the waveform of the current Icp flowing in the shunt capacitor CP.

FIG. 4 shows in parts (1) through (4) waveform diagrams explaining the action of the circuit with the shunt capacitor CP omitted from the power inverter shown in FIG. 1, with (1) showing the waveform of the voltage Vload impressed on the inductive load LD, (2) showing the waveform of the current Iload flowing in the inductive load LD, (3) showing the waveform of the current Isw2 flowing in the reverse-conductive semiconductor switch SW2 and (4) showing the waveform of the current Icm flowing in the resonant capacitor CM.

FIG. 5 is one example of a circuit diagram for an oscillation suppression circuit.

FIG. 6 is a block circuit diagram for the case where the oscillation suppression circuit shown in FIG. 5 is applied to the power inverter of FIG. 1.

FIG. 7 shows in parts (1) through (4) waveform diagrams explaining the action of the power inverter according to a first embodiment of the present invention provided with an oscillation suppression circuit, with (1) showing the waveform of the voltage Vload impressed on the inductive load LD, (2) showing the waveform of the current Iload flowing in the inductive load LD, (3) showing the waveform of the current Isw2 flowing in the reverse-conductive semiconductor switch SW2 and (4) showing the waveform of the current Icm flowing in the resonant capacitor CM.

FIG. 8 shows in parts (1) through (4) waveform diagrams explaining the action of the power inverter according to a first embodiment of the present invention in which parasitic oscillation occurs, with (1) showing the waveform of the voltage Vload impressed on the inductive load LD, (2) showing the waveform of the current Iload flowing in the inductive load LD, (3) showing the waveform of the current Isw2 flowing in the reverse-conductive semiconductor switch SW2 and (4) showing the waveform of the current Icm flowing in the resonant capacitor CM.

FIG. 9 is a circuit diagram for a power inverter according to a first embodiment of the present invention provided with a function for automatically regulating the impedance of the oscillation suppression circuit shown in FIG. 5.

FIG. 10 shows in parts (1) through (3) waveform diagrams when the switching frequency is 1,500 Hz in the power inverter according to a first embodiment of the present invention, with (1) showing the waveform of the current Iload flowing in the inductive load LD, (2) showing the waveform of the voltage Vload impressed on the inductive load LD and (3) showing the waveform of the current Isw2 flowing in the reverse-conductive semiconductor switch SW2.

FIG. 11 shows in parts (1) and (2) waveform diagrams when the switching frequency is 1,500 Hz in the power inverter according to a first embodiment of the present invention, with (1) showing the waveform diagram of the current Isw2 flowing in the reverse-conductive semiconductor switch SW2 and the amplitude of the control signal SG2 impressed on a gate GSW2 of the reverse-conductive semiconductor switch SW2 multiplied by 5,000 and (2) showing the voltage Vsw2 impressed on the reverse-conductive semiconductor switch SW2 (because this is equivalent to the voltage Vload impressed on the inductive load LD, this shows the voltage Vload impressed on the inductive load LD), and the amplitude of the control signal SG2 impressed on a gate GSW2 of the reverse-conductive semiconductor switch SW2 multiplied by 2,500.

FIG. 12 shows in parts (1) and (2) waveform diagrams when the switching frequency is 3,000 Hz in the power inverter according to a first embodiment of the present invention, with (1) showing the waveform diagram of the current Isw2 flowing in the reverse-conductive semiconductor switch SW2 and the amplitude of the control signal SG2 impressed on a gate GSW2 of the reverse-conductive semiconductor switch SW2 multiplied by 5,000 and (2) showing the voltage Vsw2 impressed on the reverse-conductive semiconductor switch SW2 (because this is equivalent to the voltage Vload impressed on the inductive load LD, this shows the voltage Vload impressed on the inductive load LD), and the amplitude of the control signal SG2 impressed on a gate GSW2 of the reverse-conductive semiconductor switch SW2 multiplied by 2,500.

FIG. 13 shows a circuit diagram for a power inverter according to a second embodiment of the present invention.

FIG. 14A is a drawing explaining the action of the power inverter shown in FIG. 13.

FIG. 14B is a drawing explaining the action of the power inverter shown in FIG. 13.

FIG. 14C is a drawing explaining the action of the power inverter shown in FIG. 13.

FIG. 14D is a drawing explaining the action of the power inverter shown in FIG. 13.

FIG. 14E is a drawing explaining the action of the power inverter shown in FIG. 13.

FIG. 14F is a drawing explaining the action of the power inverter shown in FIG. 13.

FIG. 15 shows in parts (1) through (4) waveform diagrams for explaining the action of the power inverter shown in FIG. 13, with (1) showing the waveform of the voltage Vload impressed on the inductive load LD, (2) showing the waveform of the current Iload flowing in the inductive load LD, (3) showing the waveform of the current Isw2 flowing in the reverse-conductive semiconductor switch SW2 and (4) showing the waveform of the current Icp flowing in the shunt capacitor CP.

FIG. 16 shows in parts (1) through (5) block circuit diagrams of the configuration of direct-current power supplies, with (1) showing one in which direct-current impedance is connected to the positive pole of the direct-current voltage supply, (2) showing one in which direct-current impedance is connected to the negative pole of the direct-current voltage supply, (3) showing one in which a direct-current power supply is produced using a direct-current reactor from an alternating-current power supply, (4) showing one in which a direct-current power supply is produced using an alternating-current reactor from an alternating-current power supply and (5) showing one using an alternating-current power regulator in order to adjust the quantity of alternating-current power supplied to the inductive load LD.

### BEST MODE FOR CARRYING OUT THE INVENTION

The preferred embodiments of the present invention are described below with reference to the drawings. Common constituent elements, members and processes shown in each of the drawings are labeled with the same symbols, and redundant explanation of such is omitted. In addition, the preferred embodiments are intended to be illustrative of the present invention and not limiting, for all of the characteristics noted in the preferred embodiments and combinations of such are not necessarily essential to the present invention.

Below, a self-extinguishing device indicates a device in which a conductive state (hereafter referred as an “on” state) of electric current in a forward direction flowing from the positive pole to the negative pole and a blocked state (hereafter referred to as an “off” state) are switched by a signal provided from the outside.

In addition, an reverse-conductive semiconductor switch indicates a circuit without an reverse blocking ability, in other words in which reverse conduction is possible, and in which the self-extinguishing device and a device having a rectifying action are connected in parallel such that the forward directions of each are in mutually reverse directions, or a semiconductor device equivalent to such a circuit.

In addition, the reverse-conductive semiconductor switch being brought into an on state indicates the self-extinguishing device comprising the reverse-conductive semiconductor switch being brought into a conductive state, and the reverse-conductive semiconductor switch being brought into an off state indicates the self-extinguishing device comprising the reverse-conductive semiconductor switch being brought into a blocked state. One must bear in mind that in the reverse-conductive semiconductor switch, reverse conduction is always possible regardless of whether the self-extinguishing device is in a conductive state or a blocked state.

In addition, the positive pole of the self-extinguishing device (the terminal on which a positive voltage is impressed when electric current flows in the forward direction) is defined as the positive pole of the reverse-conductive semiconductor switch, while on the other hand, the negative pole of the self-extinguishing device (the terminal on which a negative voltage is impressed when electric current flows in the forward direction) is defined as the negative pole of the reverse-conductive semiconductor switch.

### Embodiment 1

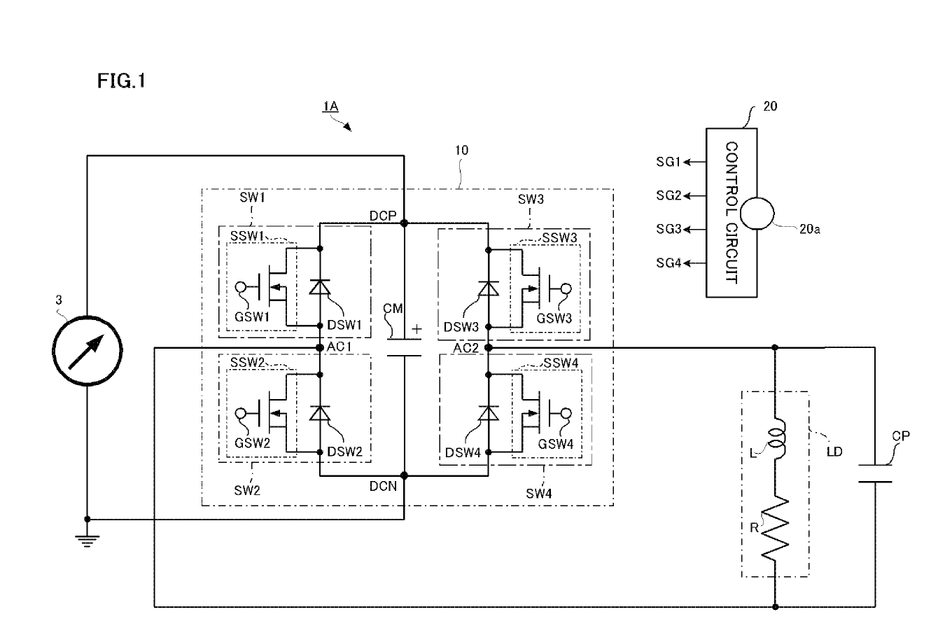

FIG. 1 is a block circuit diagram showing the composition of a power inverter 1A (hereafter referred to as a load shunt capacitor type) according to a first embodiment of the present invention. More specifically, the power inverter 1A according to this embodiment converts direct-current power into alternating-current power and supplies the alternating-current power to an inductive load LD having an inductance L and a resistance R. The power inverter 1A is provided with a full-bridge circuit 10, a direct-current current supply 3, a resonant capacitor CM, a shunt capacitor CP, an inductive load LD and a control circuit 20.

The full-bridge circuit 10 is composed of four reverse-conductive semiconductor switches SW1 to SW4 connected together in which each reverse-conductive semiconductor switch SW is composed of a self-extinguishing device SSW and a diode DSW connected in reverse-parallel, or an equivalent semiconductor device.

The full-bridge circuit 10 is composed of a first reverse-conductive semiconductor switch leg and a second reverse-conductive semiconductor switch leg, in which the first reverse-conductive semiconductor switch leg has a connection point where the first reverse-conductive semiconductor switch SW1 and the second reverse-conductive semiconductor switch SW2 are connected in series as a first alternating-current terminal AC1, and the second reverse-conductive semiconductor switch leg has a connection point where the third reverse-conductive semiconductor switch SW3 and the fourth reverse-conductive semiconductor switch SW4 are connected in series as a second alternating-current terminal AC2. The positive poles of the first reverse-conductive semiconductor switch SW1 and the third reverse-conductive semiconductor switch SW3 connected to each other to form a positive pole terminal DCP, and the negative poles of the second reverse-conductive semiconductor switch SW2 and the fourth reverse-conductive semiconductor switch SW4 connected to each other to form a negative pole terminal DCN.

The direct-current current supply 3 supplies energy consumed by the resistance R of the inductive load LD and energy that the inductive load takes to the outside (consumes) by electromagnetic induction.

The inductive load LD is, for example, an alternating-current electric motor, a load in which an inductance such as induction heating coils for heating an object through electromagnetic induction cannot be ignored, or an electric current transformer for taking out alternating-current power isolated between primary winding terminals from secondary winding terminals, and is an alternating-current load composed from a resonant reactor directly connected to the primary winding terminals, and is expressed by a series circuit of an inductor L and a resistance R. The inductive load LD is connected between the first alternating-current terminal AC1 and the second alternating-current terminal AC2 of the full-bridge circuit 10.

The resonant capacitor CM is connected between the positive pole terminal DCP and the negative pole terminal DCN of the full-bridge circuit 10. The resonant capacitor CM resonates with the inductance L of the inductive load LD. The shunt capacitor CP is connected between the first alternating-current terminal AC1 and the second alternating-current terminal AC2 of the full-bridge circuit 10, and is connected in parallel with the inductive load LD. The shunt capacitor resonates with the inductance L of the inductive load LD.

Unlike the large-capacity smoothing capacitors for stably supplying direct-current voltage used in conventional voltage-type PWM inverter circuits, the capacitance (CM) of the resonant capacitor CM and the capacitance (CP) of the shunt capacitor CP are such that the composite capacitance (CM+CP) resonates with the inductive load LD, so this may be an extremely small capacitance for absorbing (charging the resonant capacitor CM and the shunt capacitor CP) and releasing (discharging the resonant capacitor CM and the shunt capacitor CP) magnetic energy with half the period of alternating-current oscillation current flowing to the inductive load LD. In general, large-capacity smoothing capacitors use electrolytic capacitors but there are frequently problems with lifespan and reliability, and this has often led to results that cause the lifespan and reliability of conventional voltage-type PWM inverter circuits as a whole to deteriorate. In contrast, the necessary capacitance of the resonant capacitor CM and the shunt capacitor CP is sufficiently small in comparison to the smoothing capacitors of conventional voltage-type PWM inverter circuits, so although the capacitance of film capacitors, oil capacitors and the like are small compared to electrolytic capacitors, it is possible to use those with high reliability and lifespan, and it is possible to improve the lifespan and reliability of the power inverter 1A as a whole according to the present invention.

In addition, by making the capacitance (CP) of the shunt capacitor CP larger than the capacitance (CM) of the resonant capacitor CM, the characteristic is achieved that the short-circuit current that flows when the inductive load LD is short circuited virtually does not flow to the reverse-conductive semiconductor switches.

In addition, because the resonant capacitor CM is connected between the positive pole terminal DCP and the negative pole terminal DCN of the full-bridge circuit 10, it can be used as a polarized capacitor. Because the shunt capacitor CP is such that the voltage polarity between terminals changes in response to the period of the alternating-current power supplied to the inductive load LD, it can be used as a non-polarized capacitor.

In addition, the device used in switching the power inverter 1A according to the first embodiment of the present invention does not have reverse blocking ability, so reverse conduction is possible. This makes reverse voltage-resistance capacity unnecessary in the device used for switching, while such was necessary in the typical conventional electric current resonant-type inverter circuit.

With the first reverse-conductive semiconductor switch SW1 and the fourth reverse-conductive semiconductor switch SW4 as a first pair PA1 and the second reverse-conductive semiconductor switch SW2 and the third reverse-conductive semiconductor switch SW3 as a second pair PA2, the control circuit 20 controls the on and off states of reverse-conductive semiconductor switch switching so that when the first pair PA1 is brought into an on state, the second pair PA2 is brought into an off state, and when the first pair PA1 is brought into an off state, the second pair PA2 is brought into an on state. Through control by the control circuit 20, alternating-current power is impressed on the inductive load LD. In addition, the control circuit 20 can change the switching frequency in accordance with operation of or input into an external interface 20a.

By the control circuit 20 controlling the on/off state of the reverse-conductive semiconductor switches SW1 to SW4 at a switching frequency fsw of not more than the resonant frequency fres determined by the composite capacitance (CP+CM) of the resonant capacitor CM and the shunt capacitor CP and the inductance L of the inductive load LD when the reverse-conductive semiconductor switch is brought into an on state, the self-extinguishing device comprising the reverse-conductive semiconductor switch has roughly zero voltage and roughly zero current, and in addition when the reverse-conductive semiconductor switch is brought into an off state, the self-extinguishing device comprising the reverse-conductive semiconductor switch can accomplish a soft switching action at roughly zero voltage.

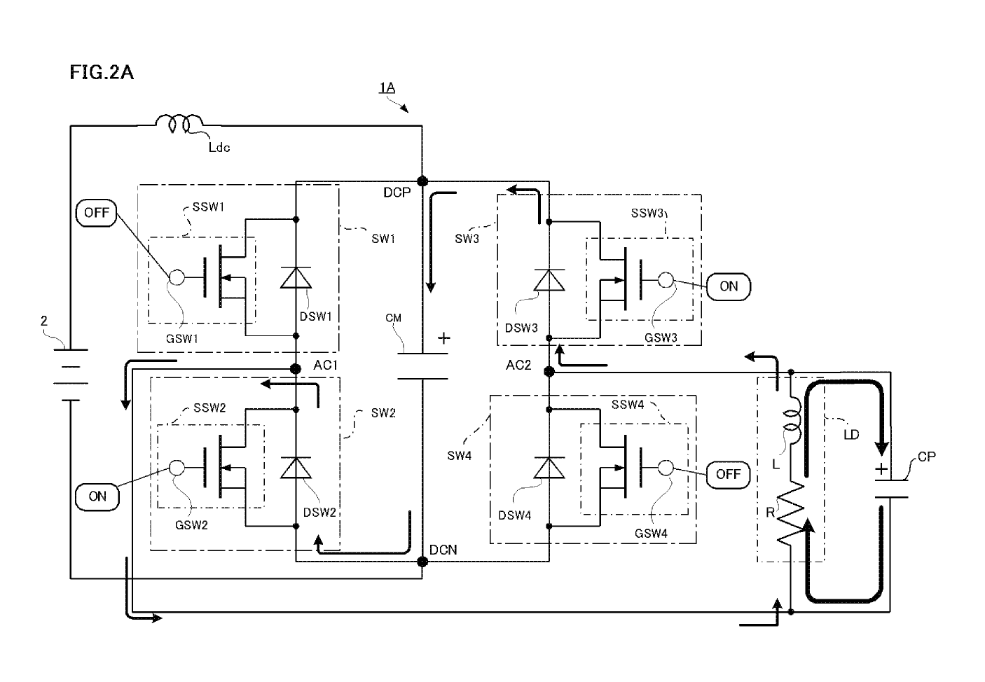

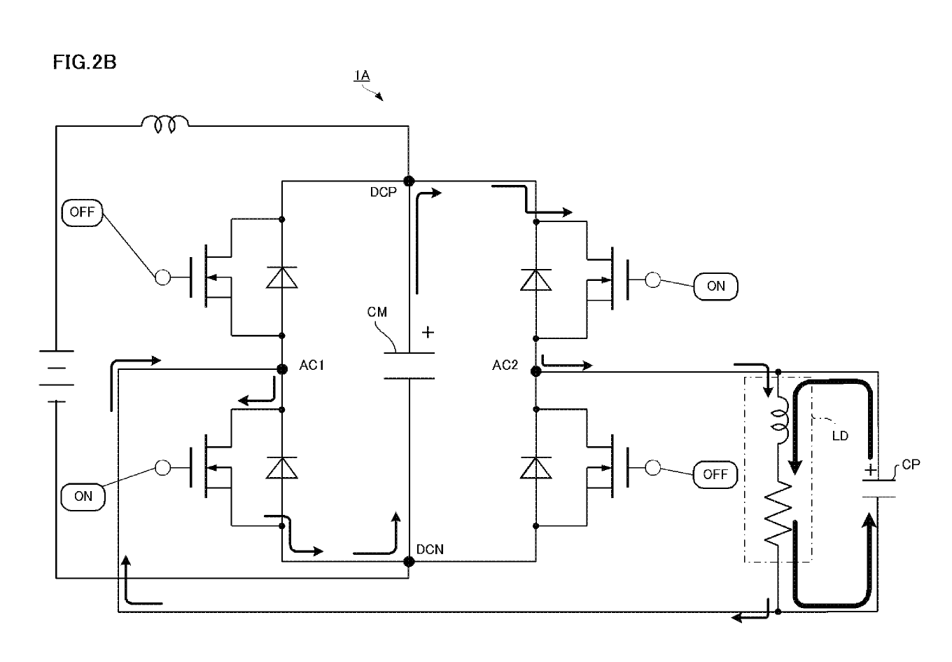

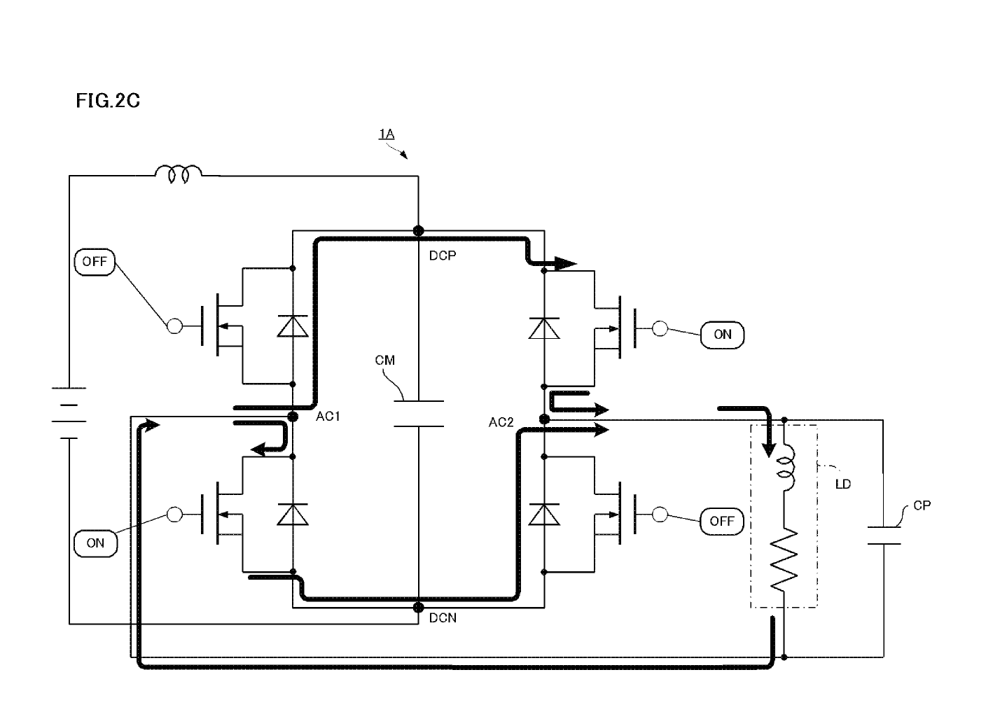

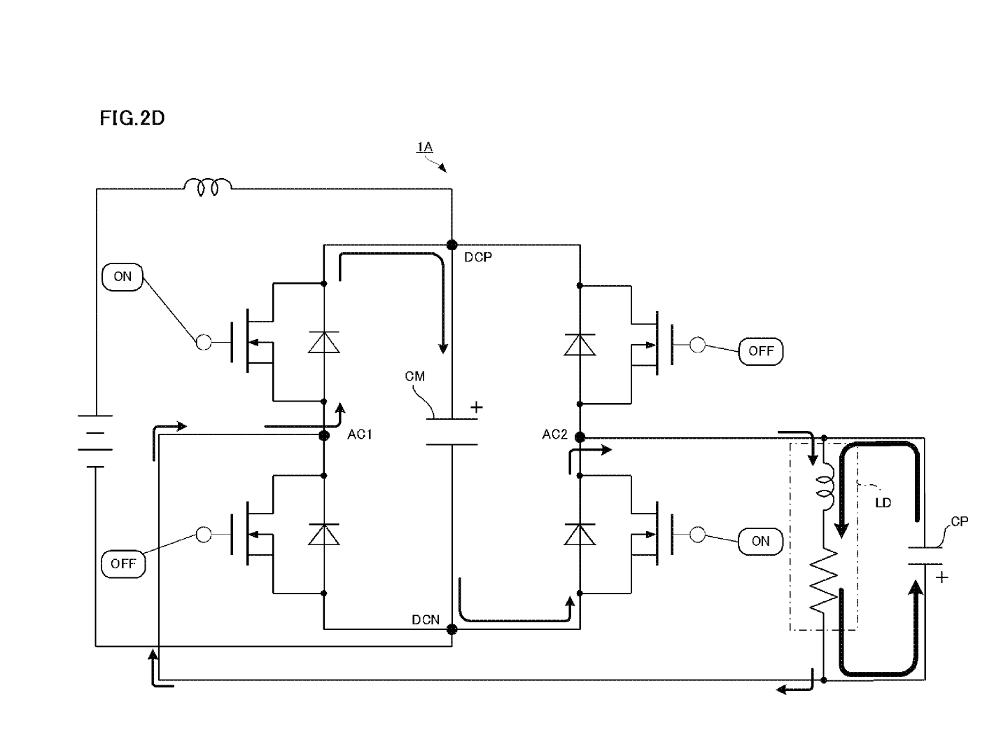

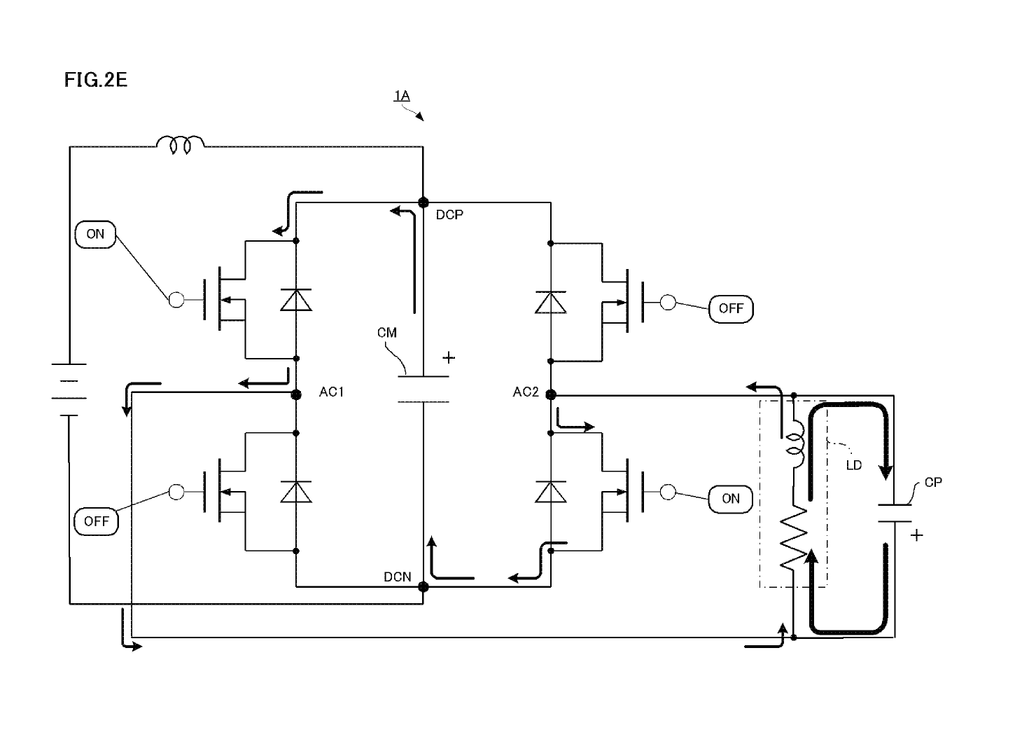

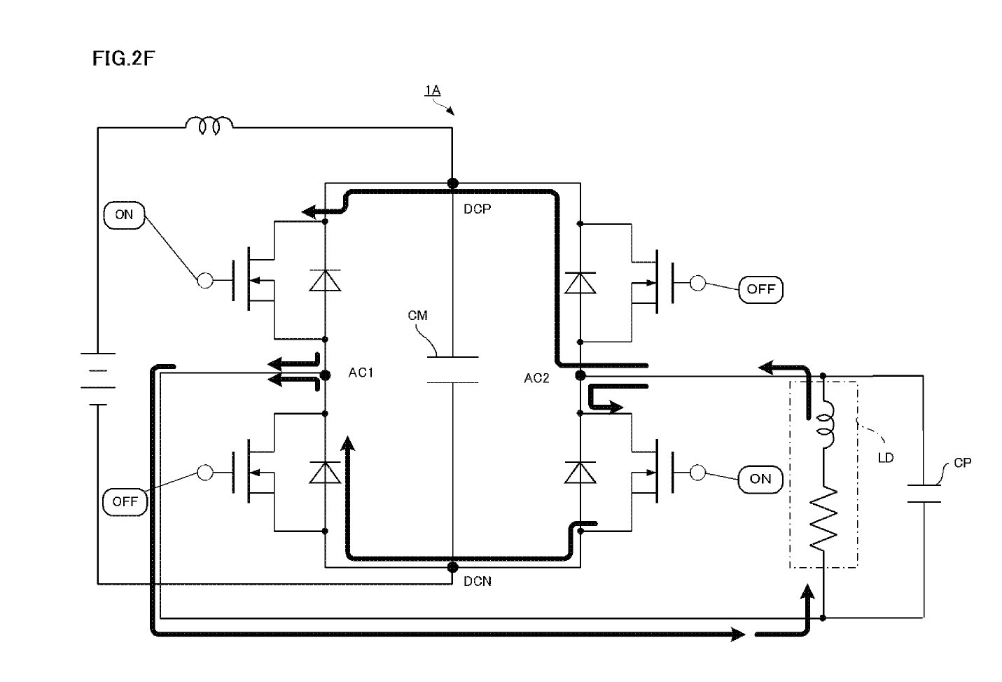

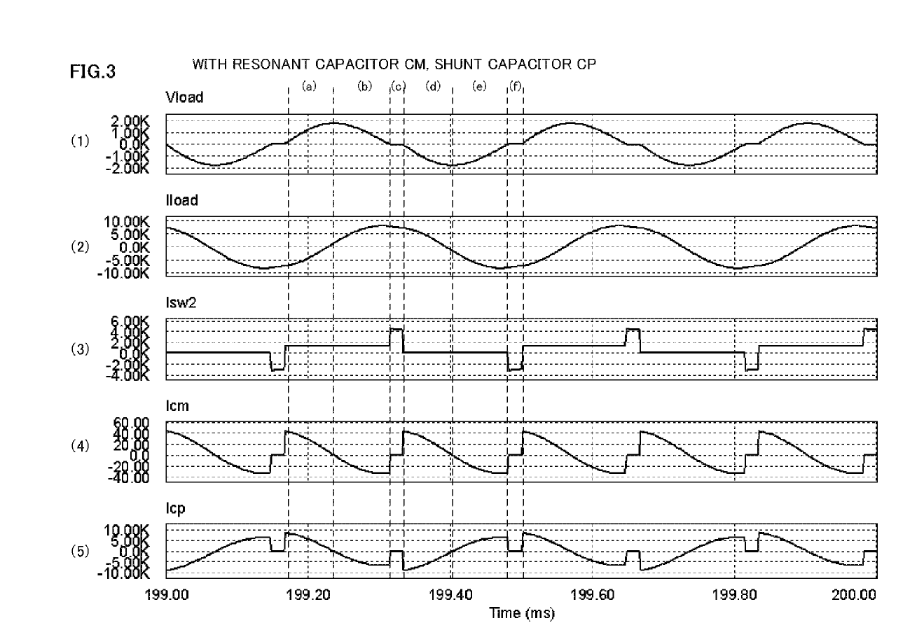

Next, the operating principle of the load shunt capacitor type power inverter having the above composition will be explained with reference to FIGS. 2A through 2F and FIG. 3. FIGS. 2A through 2F are used to explain the operating principle of the load shunt capacitor type power inverter, and the control circuit 20 is not shown.

In the explanation below, the case when the electric potential of the terminal of the shunt capacitor CP connected to the second alternating-current terminal AC2 goes from roughly zero [V] to a positive electric potential shall be expressed as “P”, and the case where the electric potential of the terminal of the shunt capacitor CP connected to the first alternating-current terminal AC1 goes from roughly zero [V] to a positive electric potential shall be expressed as “N”. The state when the shunt capacitor CP is charging, parallel connected (the state when the voltage of both terminals of the capacitor is roughly zero [V]) and discharging shall be expressed as “charging mode P” and so forth.

In addition, the arrows in FIGS. 2A through 2F indicate electric current and the direction thereof, and the thickness of the arrows indicate the size of the current. The thicknesses of the arrows are relative. In addition, the “+” symbols attached to the terminals of the resonant capacitor CM and the shunt capacitor CP indicate the state of the electric potential of those terminals. Nothing is shown when the electric potential is roughly zero [V]. In addition, the symbols “ON” and “OFF” attached to the gates of the reverse-conductive semiconductor switches indicate the conductive state and the blocked state of the self-extinguishing terminals comprising those reverse-conductive semiconductor switches, with “ON” signifying the conductive state and “OFF” signifying the blocked state. In addition, the direct-current current supply 3 is shown as a concrete example by the direct-current voltage supply 2 and the direct-current reactor Ldc connected to the positive pole terminal of the direct-current voltage supply 2. The direct-current voltage supply 2 becomes a direct-current current supply by being connected to the direct-current reactor Ldc, and continuously supplies direct current to the power inverter 1A (hereafter, the above-described direct current shall be called the supply current). In addition, section (a) of FIG. 3 corresponds to the “charging mode P” of FIG. 202A, section (b) of FIG. 3 corresponds to the “discharging mode P” of FIG. 2B, section (c) of FIG. 3 corresponds to the “parallel conduction mode P” of FIG. 2C, section (d) of FIG. 3 corresponds to the “charging mode N” of FIG. 2D, section (e) of FIG. 3 corresponds to the “discharging mode N” of FIG. 2E and section (f) of FIG. 3 corresponds to the “parallel conduction mode N” of FIG. 2F.

As the initial state, suppose a state in which the resonant capacitor CM and the shunt capacitor CP have no charge, a state in which magnet energy is stored in the inductive load LD by a resonant current, in other words a state in which the magnetic energy is stored in the inductance L of the inductive load by a resonant current flowing to the inductive load LD instead of the voltages of the respective capacitors being roughly zero [V] by resonance between the resonant capacitor CM, the shunt capacitor CP and the inductance L of the inductive load LD.

1) From the initial state, the control circuit 20 brings the second reverse-conductive semiconductor switch SW2 and the third reverse-conductive semiconductor switch SW3 into an on state and the first reverse-conductive semiconductor switch SW1 and the fourth reverse-conductive semiconductor switch SW4 into an off state, achieving the “charging mode P” shown in FIG. 2A and the state shown in section (a) of FIG. 3. In the “charging mode P” state, the current flowing by means of the magnetic energy stored in the inductance L of the inductive load LD is interrupted by the first reverse-conductive semiconductor switch SW1 and the fourth reverse-conductive semiconductor switch SW4, which are in an off state, and as a result the resonant capacitor CM and the shunt capacitor CP are charged. In addition, the energy consumed by the resistance R of the inductive load LD and the energy consumed by the electromagnetic induction of the inductive load LD are compensated for by the supply current charging the resonant capacitor CM and the shunt capacitor CP. The current flowing because of the magnetic energy stored in the inductance L of the inductive load LD, in other words the resonant current, passes through the second alternating-current terminal AC2, a diode DSW3 of the third reverse-conductive semiconductor switch SW3 and the positive pole terminal DCP and charges the resonant capacitor CM. In addition, the current flowing from the resonant capacitor CM passes through the negative pole terminal DCN, a diode DSW2 of the second reverse-conductive semiconductor switch SW2 and the first alternating-current terminal AC1 and flows to the inductive load LD. Accompanying this, virtually all of the resonant current flows to the shunt capacitor CP and charges the shunt capacitor CP.

2) Eventually, through the resonance of the resonant capacitor CM and the shunt capacitor CP with the inductance L of the inductive load LD, the “discharging mode P” shown in FIG. 2B and the state in section (b) of FIG. 3 is attained. In the “discharging mode P” state, the charge accumulated in the resonant capacitor CM and the shunt capacitor CP through the resonance of the resonant capacitor CM and the shunt capacitor CP with the inductance L of the inductive load LD becomes the resonant current and is discharged to the inductive load LD. In addition, the energy consumed by the resistance R of the inductive load LD and the energy consumed by the electromagnetic induction of the inductive load LD is compensated by the supply current continuing to flow. With regard to the resonant current, the current flowing from the resonant capacitor CM passes through the positive pole terminal DCP, the self-extinguishing device SSW3 of the third reverse-conductive semiconductor switch SW3 that is in an on state and the second alternating-current terminal AC2 and flows to the inductive load LD, and furthermore passes through the first alternating-current terminal AC1, the self-extinguishing device SSW3 of the third reverse-conductive semiconductor switch SW3 in an on state and the negative pole terminal DCN and returns to the resonant capacitor CM. In addition, the current flowing from the shunt capacitor CP flows to the inductive load LD and returns to the shunt capacitor CP. When the electric charge accumulated in the resonant capacitor CM and the shunt capacitor CP has been discharged and is gone, the voltage between both ends of both the resonant capacitor CM and the shunt capacitor CP becomes roughly zero [V], and the resonant current ceases flowing to the resonant capacitor CM and the shunt capacitor CP.

3) Accordingly, the “parallel conduction mode P” shown in FIG. 2C and the state shown in section (c) of FIG. 3 are achieved. In the “parallel conduction mode P” state, the resonant current flows as indicated by the arrow showing the current in FIG. 2C. In addition, the energy consumed by the resistance R of the inductive load LD and the energy consumed by the electromagnetic induction of the inductive load LD are compensated by the supply current continuing to flow. The resonant current flowing from the inductive load LD flows along a first path flowing to the inductive load LD passing through the first alternating-current terminal AC1, the diode DSW1 of the first reverse-conductive semiconductor switch SW1 in an off state, the positive pole terminal DCP, the self-extinguishing device SSW3 of the third reverse-conductive semiconductor switch SW3 in an on state and the second alternating-current terminal AC2, and a second path flowing to the inductive load LD passing through first alternating-current terminal AC1, the self-extinguishing element SSW2 of the second reverse-conductive semiconductor switch SW2 in an on state, the negative pole terminal DCN, the diode DSW4 of the fourth reverse-conductive semiconductor switch SW3 in an off state and the second alternating-current terminal AC2.

4) Next, when the control circuit 20 brings the first reverse-conductive semiconductor switch SW1 and the fourth reverse-conductive semiconductor switch SW4 into an on state and the second reverse-conductive semiconductor switch SW2 and the third reverse-conductive semiconductor switch SW3 into an off state, the “charging mode N” shown in FIG. 2D and the state shown in section (d) of FIG. 3 are achieved. In the “charging mode N” state, the current flowing because of the magnetic energy accumulated in the inductance L of the inductive load LD is blocked by the second reverse-conductive semiconductor switch SW2 and the third reverse-conductive semiconductor switch SW3, which are in an off state, and as a result the resonant capacitor CM and the shunt capacitor CP are charged. In addition, the energy consumed by the resistance R of the inductive load LD and the energy consumed by the electromagnetic induction of the inductive load LD are compensated by the supply current charging the resonant capacitor CM and the shunt capacitor CP. The electric current flowing because of the magnetic energy stored in the inductance L of the inductive load LD, that is to say the resonant current, passes through the first alternating-current terminal AC1, the diode DSW1 of the first reverse-conductive semiconductor switch SW1 and the positive pole terminal DCP and charges the resonant capacitor CM. In addition, the current flowing from the resonant capacitor CM passes through the negative pole terminal DCN, the diode DSW 4 of the fourth reverse-conductive semiconductor switch SW4 and the second alternating-current terminal AC2 and flows to the inductive load LD. Furthermore, accompanying this most of the resonant current flows to the shunt capacitor CP and charges the shunt capacitor CP. In addition, when charging the shunt capacitor CP, charging is accomplished with an reverse polarity to the “charging mode P” state.

5) Eventually, through the resonance of the resonant capacitor CM and the shunt capacitor CP with the inductance L of the inductive load LD, the “discharging mode N” shown in FIG. 2E and the state in section (e) of FIG. 3 are attained. In the “discharging mode N” state, the charge accumulated in the resonant capacitor CM and the shunt capacitor CP through the resonance of the resonant capacitor CM and the shunt capacitor CP with the inductance L of the inductive load LD becomes the resonant current and is discharged to the inductive load LD. In addition, the energy consumed by the resistance R of the inductive load LD and the energy consumed by the electromagnetic induction of the inductive load LD are compensated by the supply current continuing to flow. With regard to the resonant current, the current flowing from the resonant capacitor CM passes through the positive pole terminal DCP, the self-extinguishing device SSW1 of the first reverse-conductive semiconductor switch SW1 that is in an on state and the first alternating-current terminal AC1 and flows to the inductive load LD, and furthermore passes through the second alternating-current terminal AC2, the self-extinguishing device SSW4 of the fourth reverse-conductive semiconductor switch SW4 in an on state and the negative pole terminal DCN and returns to the resonant capacitor CM. In addition, the current flowing from the shunt capacitor CP flows to the inductive load LD and returns to the shunt capacitor CP. When the electric charge accumulated in the resonant capacitor CM and the shunt capacitor CP has been discharged and is gone, the voltage between both of ends of both the resonant capacitor CM and the shunt capacitor CP becomes roughly zero [V], and the resonant current ceases flowing to the resonant capacitor CM and the shunt capacitor CP.

6) Accordingly, the “parallel conduction mode N” shown in FIG. 2F and the state shown in section (f) of FIG. 3 are achieved. In the “parallel conduction mode N” state, the resonant current flows as indicated by the arrow showing the current in FIG. 2F. In addition, the energy consumed by the resistance R of the inductive load LD and the energy consumed by the electromagnetic induction of the inductive load LD are compensated by the supply current continuing to flow. The resonant current flowing from the inductive load LD flows along a first path flowing to the inductive load LD passing through the second alternating-current terminal AC2, the diode DSW3 of the third reverse-conductive semiconductor switch SW3 in an off state, the positive pole terminal DCP, the self-extinguishing device SSW1 of the first reverse-conductive semiconductor switch SW1 in an on state and the first alternating-current terminal AC1, and a second path flowing to the inductive load LD passing through the second alternating-current terminal AC2, the self-extinguishing element SSW4 of the fourth reverse-conductive semiconductor switch SW4 in an on state, the negative pole terminal DCN, the diode DSW2 of the second reverse-conductive semiconductor switch SW2 in an off state and the first alternating-current terminal AC1.

7) When the control circuit 20 next brings the second reverse-conductive semiconductor switch SW2 and the third reverse-conductive semiconductor switch SW3 into an on state and the first reverse-conductive semiconductor switch SW1 and the fourth reverse-conductive semiconductor switch SW4 into an off state, the “charging mode P” shown in FIG. 2A and the state shown in section (a) of FIG. 3 are again attained.

The power inverter 1A in a steady state repeats the above-described operations and can provide alternating power to the inductive load LD.

In the above-described operations, the resonant capacitor CM and the shunt capacitor CP divide the current flowing to the inductive load LD, that is to say the resonant current. For this reason, the resonant current Iswres flowing to the first reverse-conductive semiconductor switch SW1 through SW4 becomes as described by the following equation (1).

Iswres≈(CM/(CP+CM))·Ildres (1)

Here, the resonant current Iswres is the effective value of the resonant current flowing in the reverse-conductive semiconductor switch switches SW1 through SW4, Ildres is the effective value of the resonant current flowing through the inductive load LD, (CM) is the capacitance of the resonant capacitor CM and (CP) is the capacitance of the shunt capacitor CP. All of the effective values are values of the resonant condition. Accordingly, when the desire is to make the current flowing to the reverse-conductive semiconductor switches SW1 to SW4 small, the capacitance (CP) of the shunt capacitor CP may be enlarged compared to the capacitance (CM) of the resonance capacitor CM so as to satisfy the below-described conditions.

The shunt capacitor CP is a non-polarized capacitor that can be used in an alternating current circuit and acts as a composite capacitor with the resonant capacitor CM. The capacitance of the capacitor determined from the resonant frequency fres is the capacitance of this composite capacitor (the sum of the capacitance (CP) of the shunt capacitor CP and the capacitance (CM) of the resonant capacitor CM). Hereafter, a plurality of capacitors having the capacitance of the composite capacitor and connected in parallel will be abbreviated as composite capacitor C.

Taking the maximum value of the frequency of the alternating power sent to the inductive load LD to be fmax, the capacitance of the composite capacitor to be (C=CM+CP) and the inductance of the inductance L of the inductive load LD to be (L), these must satisfy the following equation (2).

fmax≦1/(2·π·√(L·C)) (2)

Suppose the above equation (2) is not satisfied. The resonance period “1/fres” of the composite capacitor C and the inductance L of the inductive load LD becomes larger than the switching frequency “1/fsw”, and as long as the charge accumulated in the composite capacitor C does not disappear, the on and off states of the reverse-conductive semiconductor switches SW1 to SW4 are changed through switching. At this time, because charge is accumulated in the shunt capacitor CP as well, the shunt capacitor CP and the resonant capacitor CM short circuit because of the switching, creating the worry that the reverse-conductive semiconductor switches SW1 to SW4 could cause short-circuit damage. Accordingly, the above equation (2) must be satisfied. In other words, the control circuit 20 needs to control the on and off states of the reverse-conductive semiconductor switches SW1 to SW4 at a switching frequency fsw that is no more than the resonant frequency fres determined by the capacitance (C=CM+

CP) of the composite capacitor of the resonant capacitor CM and the shunt capacitor CP, and the inductance L of the inductive load LD.

Parts (1) through (5) of FIG. 3 show the voltage waveforms and the current waveforms of the s of the power inverter 1A shown in FIG. 1. These are waveforms assuming the capacitance C of the composite capacitor C is 200 μF, the capacitance of the shunt capacitor CP is 199 μF, the capacitance of the resonant capacitor CM is 1 μF, the inductance of the inductance L of the inductive load LD is 10.5 μH, the resistance of the resistance R of the inductive load LD is 0.04Ω, the inductance of the direct-current reactor Ldc is 1 mH, the output voltage of the direct-current power supply 2 is 1,000 V and the switching frequency fres of the control circuit 20 is 3,000 Hz.

Part (1) of FIG. 3 shows the voltage Vload impressed on the inductive load LD, in other words the output voltage. In addition, part (2) of FIG. 3 shows the current Iload flowing to the inductive load LD, in other words the output current. Part (3) of FIG. 3 shows the current Isw2 flowing to the reverse-conductive semiconductor switch SW2, part (4) of FIG. 3 shows the current Icm flowing to the resonant capacitor CM, and part (5) of FIG. 3 shows the current Icp flowing to the shunt capacitor CP.

As shown in part (1) of FIG. 3, a pulse voltage in which positive and negative alternate occurs in the voltage Vload impressed on the inductive load LD because of the resonance between the composite capacitor C and the inductance L included in the inductive load LD, and switching. In addition, as shown in part (2) of FIG. 3, the current Iload flowing to the inductive load LD creates an alternating current whose phase lags the output voltage Vload because of the inductance L. Furthermore, as shown in parts (3) through (5) of FIG. 3, the electric current flowing to the reverse-conductive semiconductor switch SW2 is relatively small, and times when a large current flows are limited to the parallel conduction mode P and the parallel conduction mode N. This is because originally most of the current to be supplied flowing to the reverse-conductive semiconductor switches is supplied by the shunt capacitor CP.

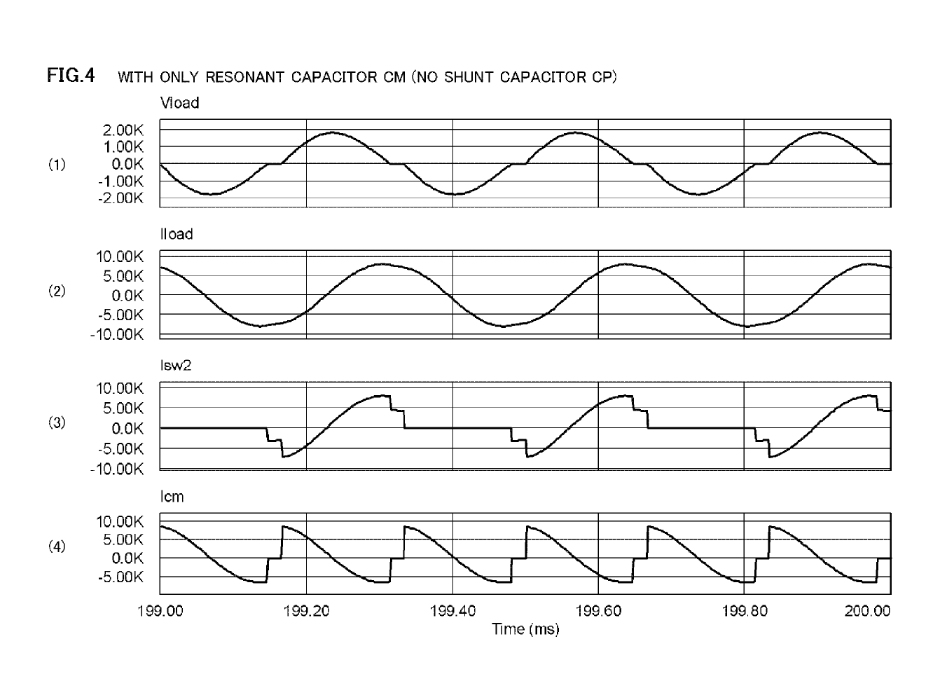

On the other hand, parts (1) through (5) in FIG. 4 show the voltage waveforms, and the current waveforms, of the various parts of the power inverter disclosed in Patent Literature 1 (in other words, a circuit in which the shunt capacitor CP is omitted from the circuit of FIG. 1). These are waveforms assuming the capacitance of the resonant capacitor CM is 200 μF, the inductance of the inductance L of the inductive load LD is 10.5 μH, the resistance of the resistance R of the inductive load LD is 0.04Ω, the inductance of the direct-current reactor Ldc is 1 mH, the output voltage of the direct-current power supply 2 is 1,000 V and the switching frequency fsw of the control circuit 20 is 3,000 Hz.

Part (1) of FIG. 4 shows the voltage Vload impressed on the inductive load LD, part (2) of FIG. 4 shows the current Iload flowing to the inductive load LD, part (3) of FIG. 4 shows the current Isw2 flowing to the reverse-conductive semiconductor switch SW2 and part (d) of FIG. 4 shows the current Icm flowing to the resonant capacitor CM.

As shown in part (1) of FIG. 4, a pulse voltage in which positive and negative alternate occurs in the voltage Vload impressed on the inductive load LD because of the resonance between the resonant capacitor CM and the inductance L included in the inductive load LD, and switching. In addition, as shown in part (2) of FIG. 4, the current Iload flowing to the inductive load LD creates an alternating current whose phase lags the output voltage Vload because of the inductance L. Furthermore, as shown in parts (3) through (4) of FIG. 4, it can be seen that the current Isw2 flowing to the reverse-conductive semiconductor switch SW2 is around half the volume of the current Iload flowing to the inductive load LD.

By comparing part (3) of FIG. 3 and part (3) of FIG. 4, it can be seen that in the charging mode P and the charging mode N, and in the discharging mode P and the discharging mode N, of the power inverter 1A according to the first embodiment of the present invention, the current flowing to the various reverse-conductive semiconductor switches is considerably smaller than the current flowing to the various reverse-conductive semiconductor switches in those modes in the power inverter disclosed in Patent Literature 1. On the other hand, the current does not become smaller in the parallel conduction mode P and the parallel conduction mode N of the power inverter 1A according to the first embodiment of the present invention. This is because in the power inverter 1A according to the first embodiment of the present invention, the composite capacitor C and the inductance L of the inductive load LD resonate, the electric charge accumulated in the composite capacitor C is discharged each half-period of switching, and the voltage of both terminals of the composite capacitor C (the voltages both of ends of each of the multiple capacitors connected in parallel and having the capacitance of the composite capacitor) becomes roughly zero [V]. This is because if there is no fluctuation in the charge accumulated in the composite capacitor C (in other words, in the parallel conduction mode P and the parallel conduction mode N states), no current flows to the composite capacitor C.

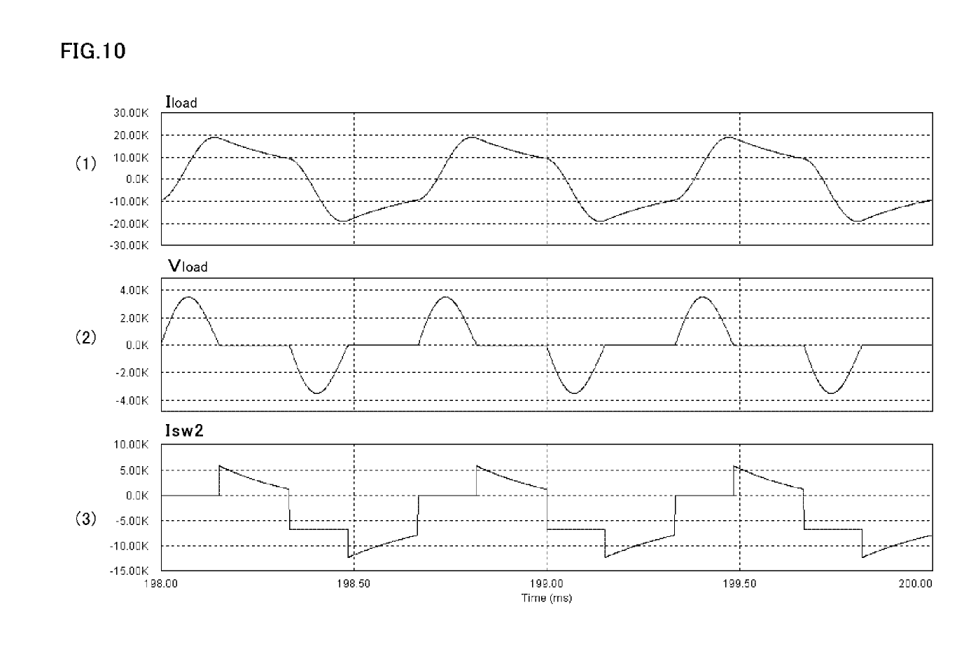

Next, the power inverter 1A shown in FIG. 1 being a variable frequency circuit will be described. Parts (1) through (3) of FIG. 10 show the load current Iload, the load voltage Vload and the current Isw2 flowing to the reverse-conductive semiconductor switch SW2 when the switching frequency fsw of the reverse-conductive semiconductor switches SW1 through SW4 is 1,500 Hz, under the control of the control circuit 20. The circuit constant is the same as when the properties of parts (1) through (5) of FIG. 3 were obtained. By comparing FIG. 10 and parts (1) through (5) of FIG. 3 it can be seen that there is no large waveform chaos other than that the time when the voltage of the load voltage Vload is roughly zero [V] caused by changes in the switching frequency fsw is increased. Through this, it can be seen that in the power inverter 1A the frequency of the load voltage Vload and the load current Iload can be changed by simply changing the switching frequency fsw by means of the control circuit 20.

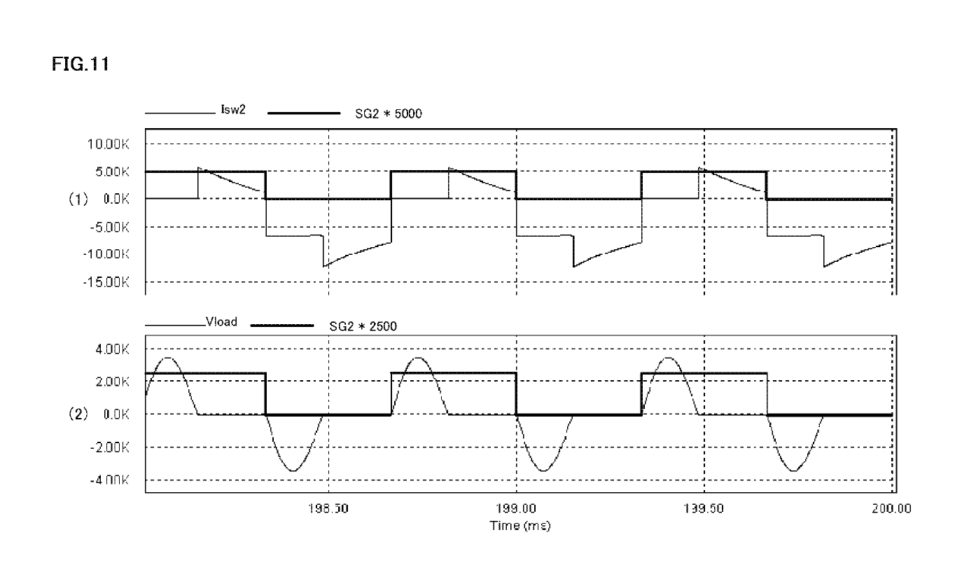

Next, in the power inverter 1A shown in FIG. 1, the possibility of soft switching is explained. Part (1) of FIG. 11 shows the waveform of the electric current Isw2 that flows in the reverse-conductive semiconductor switch SW2 when the switching frequency fsw is 1,500 Hz, and the waveform of the control signal SG2 that controls the on/off state of the reverse-conductive semiconductor switch SW2 (the voltage amplitude of the control signal SG2 is shown enlarged. Roughly 5.00 K [V] indicates the on state, and roughly 0 [V] shows the off state). Part (2) of FIG. 11 shows the waveform of the voltage Vsw2 impressed on the reverse-conductive semiconductor switch SW2 when the switching frequency fsw is 1,500 Hz (this is equivalent to the voltage Vload impressed on the inductive load LD, and thus indicates the voltage Vload impressed on the inductive load LD), and the waveform of the control signal SG2 (the voltage amplitude of the control signal SG2 is shown enlarged. Roughly 2.50 K [V] indicates the on state, and roughly 0 [V] shows the off state). As shown in parts (1) and (2) of FIG. 11, it is possible to confirm that when the reverse-conductive semiconductor switch SW2 is in an on state, the voltage Vsw2 impressed on the reverse-conductive semiconductor switch SW2 is roughly zero [V], and even when the reverse-conductive semiconductor switch SW2 becomes in an off state, the voltage Vsw2 impressed on the reverse-conductive semiconductor switch SSW2 is similarly roughly zero [V].

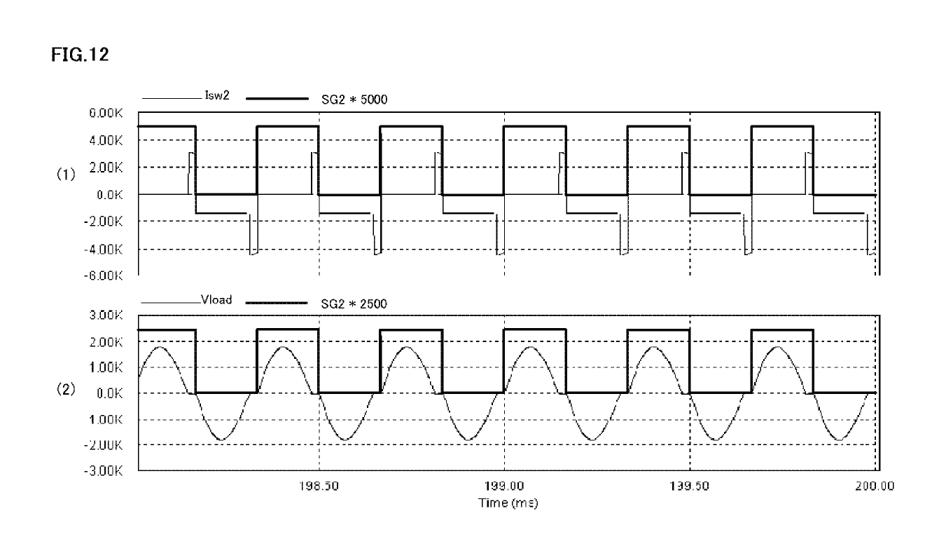

Part (1) of FIG. 12 shows the waveform of the electric current Isw2 that flows in the reverse-conductive semiconductor switch SW2 when the switching frequency fsw is 3,000 Hz, and the waveform of the control signal SG2 that controls the on/off state of the reverse-conductive semiconductor switch SW2 (the voltage amplitude of the control signal SG2 is shown enlarged. Roughly 5.00 K [V] indicates the on state, and roughly 0 [V] shows the off state). Part (2) of FIG. 12 shows the waveform of the voltage Vsw2 impressed on the reverse-conductive semiconductor switch SW2 when the switching frequency fsw is 3,000 Hz (this is equivalent to the voltage Vload impressed on the inductive load LD, and thus indicates the voltage Vload impressed on the inductive load LD), and the waveform of the control signal SG2 (the voltage amplitude of the control signal SG2 is shown enlarged. Roughly 2.50 K [V] indicates the on state, and roughly 0 [V] shows the off state). As shown in parts (1) and (2) of FIG. 12, it is possible to confirm that soft switching can be similarly realized even when the switching frequency fsw is 3,000 Hz.

With the load shunt capacitor type of load inverter 1A as described by the first embodiment of the present invention above, the power inverter 1A can reduce the resonant current flowing in the reverse-conductive semiconductor switches SW1 to SW4 by the shunt capacitor CP being connected in parallel with the inductive load LD.

### Embodiment 2

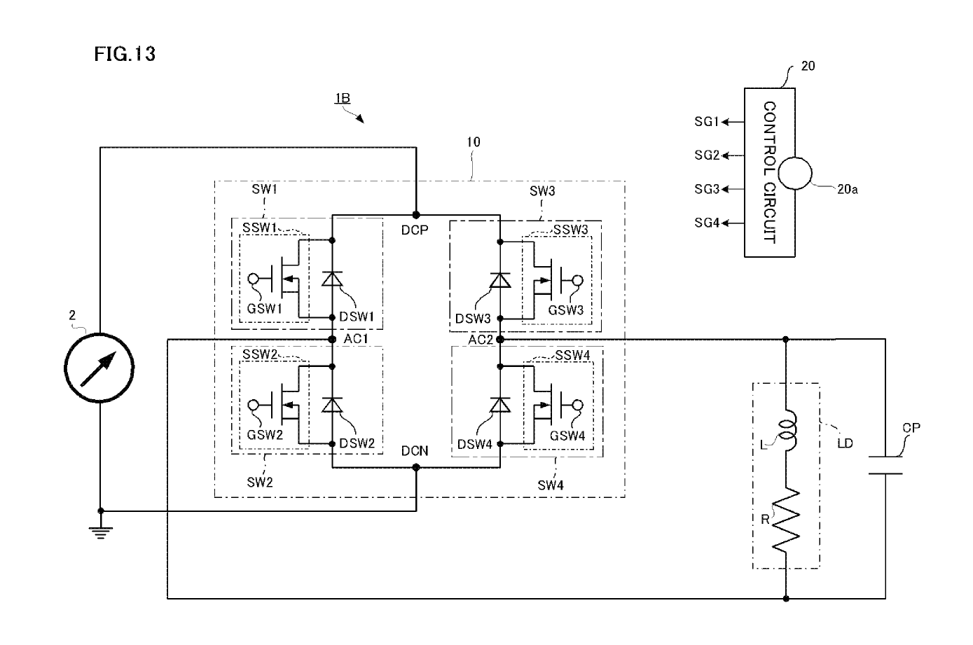

FIG. 13 is a block circuit diagram showing the composition of a power inverter 1B (hereafter, referred to as a load parallel capacitor type) according to a second embodiment of the present invention. In the power inverter 1B according to the second embodiment of the present invention, constituent elements, members and processes that are the same as in the power inverter A1 according to the first embodiment of the present invention are labeled with the same symbols, and redundant explanation of such is omitted.

The power inverter 1B according to this embodiment does not use the resonant capacitor CM in the power inverter 1A according to the first embodiment of the present invention and uses only the shunt capacitor CP, with this shunt capacitor CP connected in parallel with the inductive load LD. To be more specific, the power inverter 1B according to the present embodiment converts direct-current power into alternating-current power and supplies the alternating-current power to the inductive load LD having an inductance L and a resistance R. The power inverter 1B is provided with a full-bridge circuit 10, a direct-current current supply 3, a shunt capacitor CP, an inductive load LD and a control circuit 20.

The shunt capacitor CP of the power inverter 1B according to the present embodiment is connected between the first alternating-current terminal AC1 and the second alternating-current terminal AC2 of the full-bridge circuit 10, and is connected in parallel with the inductive load LD. The shunt capacitor CP alone resonates with the inductance L of the inductive load LD.

Next, the characteristics of the power inverter 1B according to the second embodiment of the present invention will be explained. The basic characteristics are the same as the power inverter 1A according to the first embodiment of the present invention, so only different characteristics will be discussed.

In the power inverter 1B according to the second embodiment of the present invention, the resonant frequency fres is determined by the capacitance (CP) of the shunt capacitor CP and the inductance L of the inductive load LD alone. The control circuit 20 of the power inverter 1B according to this embodiment can accomplish a soft switching action in which the self-extinguishing device comprising each reverse-conductive semiconductor switch has roughly zero voltage or roughly zero current when the reverse-conductive semiconductor switch is in an on state and the self-extinguishing device comprising each reverse-conductive semiconductor switch has roughly zero voltage when the reverse-conductive semiconductor switch is in an off state, by controlling the on/off state of the reverse-conductive semiconductor switches SW1 to SW4 at a switching frequency fsw that is no more than the resonant frequency fres determined by the capacitance CP of the shunt capacitor CP and the inductance L of the inductive load LD.

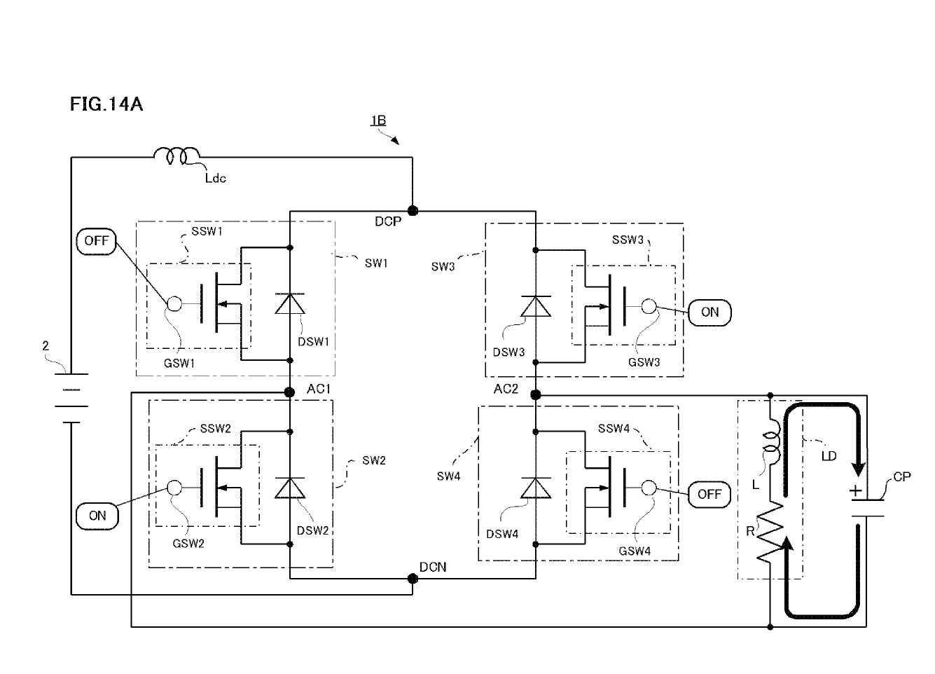

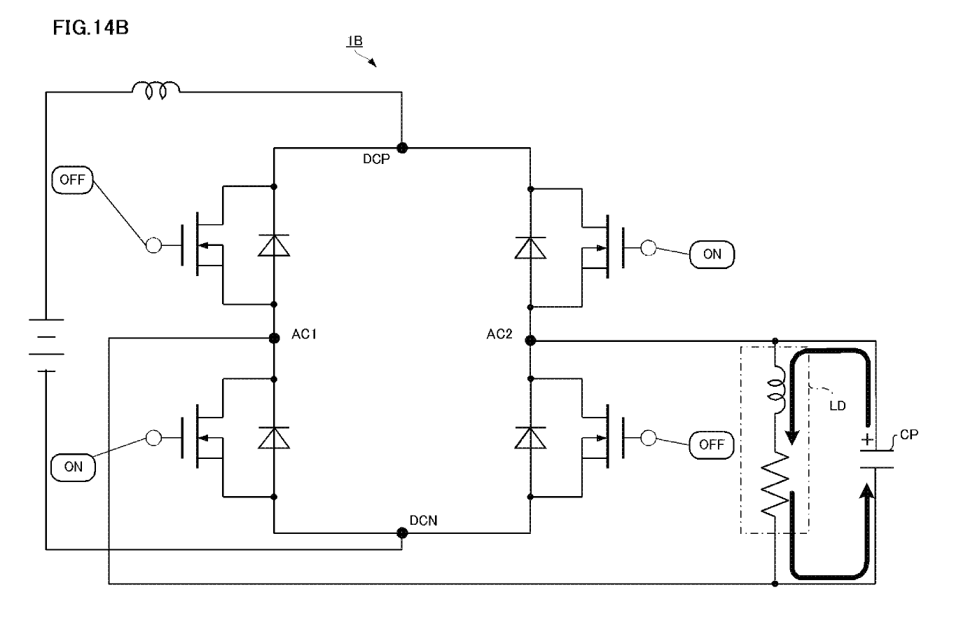

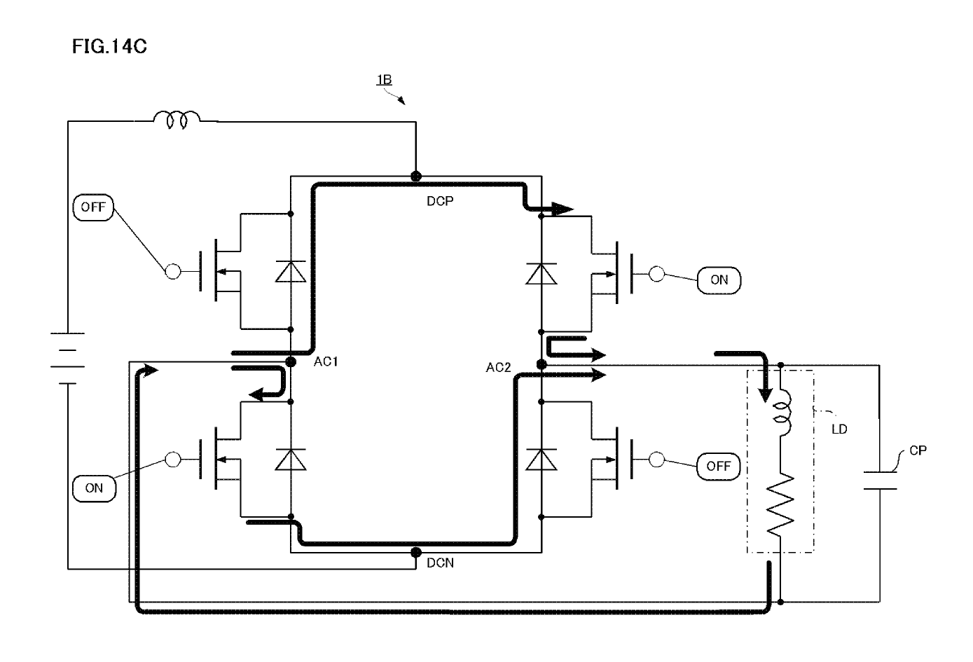

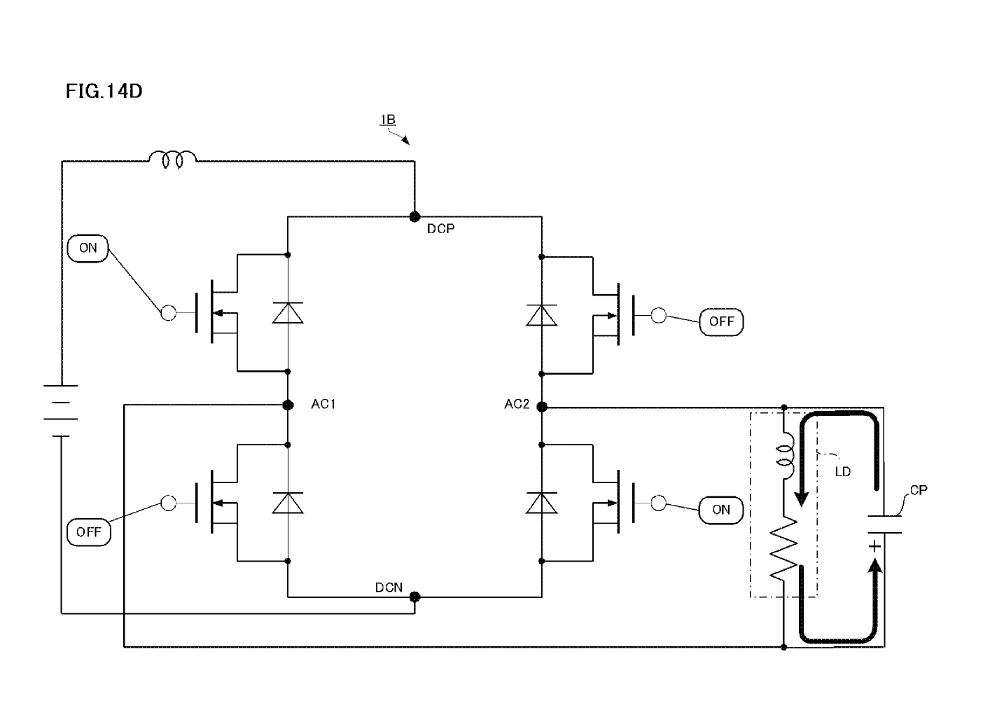

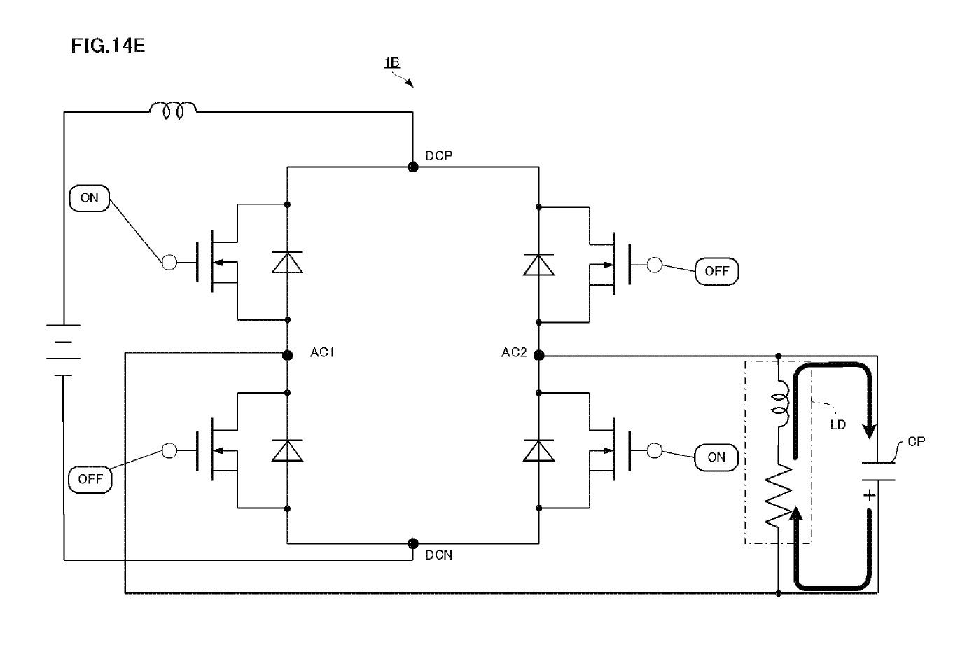

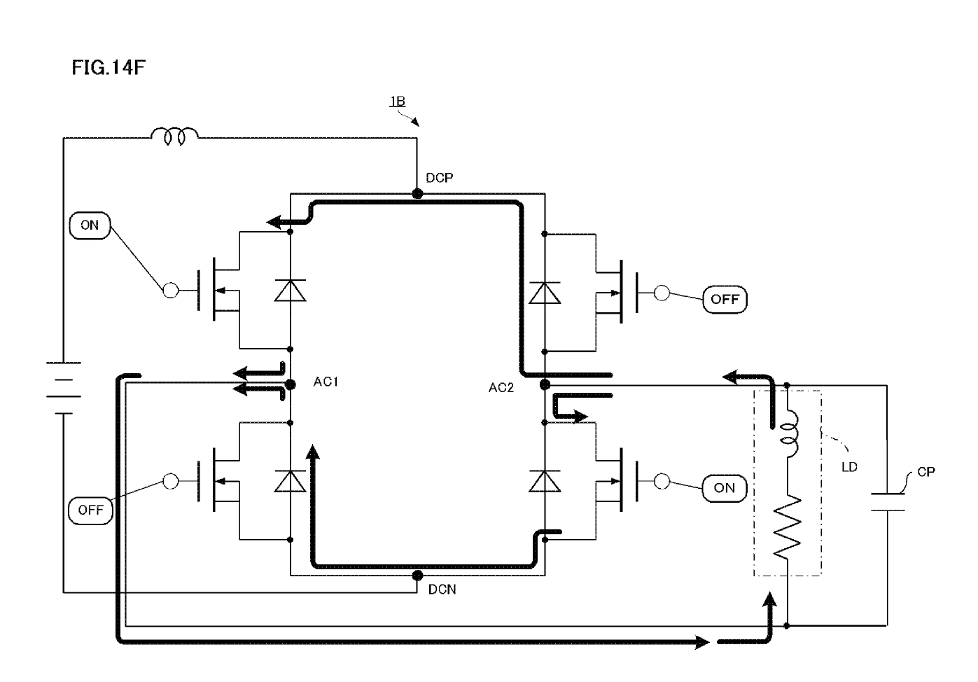

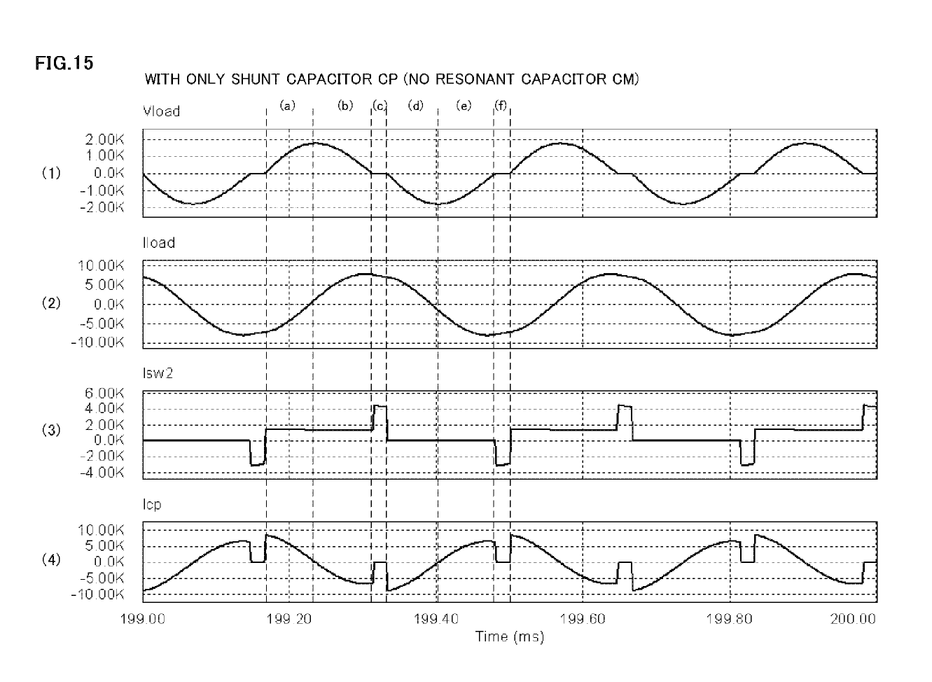

Next, the operating principle of the load parallel capacitor type power inverter having the above composition is described with reference to FIGS. 14A through 14F and FIG. 15. FIGS. 14A through 14F are used to explain the operating principle of the load parallel capacitor type power inverter, but the control circuit 20 is not represented. In the explanation below, the case when the electric potential of the terminal of the shunt capacitor CP connected to the second alternating-current terminal AC2 goes from roughly zero [V] to a positive electric potential shall be expressed as “P”, and the case where the electric potential of the terminal of the shunt capacitor CP connected to the first alternating-current terminal AC1 goes from roughly zero [V] to a positive electric potential shall be expressed as “N”. The state when the shunt capacitor CP is charging, parallel connected (the state when the voltage of both terminals of the capacitor is roughly zero [V]) and discharging shall be expressed as “charging mode P” and so forth.

In addition, the arrows in FIGS. 14A through 14F indicate electric current and the direction thereof, and the thickness of the arrows indicate the size of the current. The thicknesses of the arrows are relative. In addition, the “+” symbols attached to the terminals of the shunt capacitor CP indicate the state of the electric potential of those terminals. Nothing is shown when the electric potential is roughly zero [V]. In addition, the symbols “ON” and “OFF” attached to the gates of the reverse-conductive semiconductor switches indicate the conductive state and the blocking state of the self-extinguishing terminals comprising those reverse-conductive semiconductor switches, with “ON” signifying the conductive state and “OFF” signifying the blocked state. In addition, the direct-current current supply 3 is shown as a concrete example by the direct-current voltage supply 2 and the direct-current reactor Ldc connected to the positive pole terminal of the direct-current voltage supply 2. The direct-current voltage supply 2 becomes a direct-current current supply by being connected to the direct-current reactor Ldc, and continuously supplies direct-current electricity to the power inverter 1B (hereafter, the above-described direct-current electricity shall be called the supply current.)

In addition, section (a) of FIG. 15 corresponds to the “charging mode P” of FIG. 14A, section (b) of FIG. 15 corresponds to the “discharging mode P” of FIG. 14B, section (c) of FIG. 15 corresponds to the “parallel conduction mode P” of FIG. 14C, section (d) of FIG. 15 corresponds to the “charging mode N” of FIG. 14D, section (e) of FIG. 15 corresponds to the “discharging mode N” of FIG. 14E and section (f) of FIG. 15 corresponds to the “parallel conduction mode N” of FIG. 14F.

As the initial state, suppose a state in which the shunt capacitor CP has no charge, a state in which magnetic energy is stored in the inductive load LD by a resonant current, in other words a state in which magnetic energy is stored in the inductance L of the inductive load by a resonant current flowing to the inductive load LD instead of the voltages of the respective capacitors being roughly zero [V] by resonance between the shunt capacitor CP and the inductance L of the inductive load LD.

1) From the initial state, the control circuit 20 brings the second reverse-conductive semiconductor switch SW2 and the third reverse-conductive semiconductor switch SW3 into an on state and the first reverse-conductive semiconductor switch SW1 and the fourth reverse-conductive semiconductor switch SW4 into an off state, achieving the “charging mode P” shown in FIG. 14A and the state shown in section (a) of FIG. 15. In the “charging mode P” state, the current flowing by means of the magnetic energy stored in the inductance L of the inductive load LD is interrupted by the first reverse-conductive semiconductor switch SW1 and the fourth reverse-conductive semiconductor switch SW4, which are in an off state and thus cannot flow to the bridge circuit 10, and as a result the shunt capacitor CP is charged. In addition, the energy consumed by the resistance R of the inductive load LD and the energy consumed by the electromagnetic induction of the inductive load LD are compensated by the supply current charging the shunt capacitor CP.

2) Eventually, through the resonance of the shunt capacitor CP with the inductance L of the inductive load LD, the “discharging mode P” shown in FIG. 14B and the state in section (b) of FIG. 15 is attained. In the “discharging mode P” state, the charge accumulated in the shunt capacitor CP through the resonance of the shunt capacitor CP with the inductance L of the inductive load LD becomes the resonant current and is discharged to the inductive load LD. In addition, the energy consumed by the resistance R of the inductive load LD and the energy consumed by the electromagnetic induction of the inductive load LD is compensated by the supply current continuing to flow. With regard to the resonant current, the current flowing from the shunt capacitor CP flows to the inductive load LD and returns to the shunt capacitor CP. When the electric charge accumulated in the shunt capacitor CP has been discharged and is gone, the voltage between both ends of the shunt capacitor CP becomes roughly zero [V], and the resonant current ceases flowing to the shunt capacitor CP.

3) Accordingly, the “parallel conduction mode P” shown in FIG. 14C and the state shown in section (c) of FIG. 15 are achieved. In the “parallel conduction mode P” state, the resonant current flows as indicated by the arrow showing the current in FIG. 14C. In addition, the energy consumed by the resistance R of the inductive load LD and the energy consumed by the electromagnetic induction of the inductive load LD are compensated by the supply current continuing to flow. The resonant current flowing from the inductive load LD flows along a first path flowing to the inductive load LD passing through the first alternating-current terminal AC1, the diode DSW1 of the first reverse-conductive semiconductor switch SW1 in an off state, the positive pole terminal DCP, the self-extinguishing device SSW3 of the third reverse-conductive semiconductor switch SW3 in an on state and the second alternating-current terminal AC2, and a second path flowing to the inductive load LD passing through first alternating-current terminal AC1, the self-extinguishing element SSW2 of the second reverse-conductive semiconductor switch SW2 in an on state, the negative pole terminal DCN, the diode DSW4 of the fourth reverse-conductive semiconductor switch SW3 in an off state and the second alternating-current terminal AC2.

4) Next, when the control circuit 20 brings the first reverse-conductive semiconductor switch SW1 and the fourth reverse-conductive semiconductor switch SW4 into an on state and the second reverse-conductive semiconductor switch SW2 and the third reverse-conductive semiconductor switch SW3 into an off state, the “charging mode N” shown in FIG. 14D and the state shown in section (d) of FIG. 15 are achieved. In the “charging mode N” state, the current flowing because of the magnetic energy accumulated in the inductance L of the inductive load LD is blocked by the second reverse-conductive semiconductor switch SW2 and the third reverse-conductive semiconductor switch SW3, which are in an off state, and as a result the shunt capacitor CP is charged. When charging the shunt capacitor CP, charging is accomplished with a reverse polarity to the “charging mode P” state. In addition, the energy consumed by the resistance R of the inductive load LD and the energy consumed by the electromagnetic induction of the inductive load LD are compensated by the supply current charging the shunt capacitor CP.

5) Eventually, through the resonance of the shunt capacitor CP with the inductance L of the inductive load LD, the “discharging mode N” shown in FIG. 14E and the state in section (e) of FIG. 15 are attained. In the “discharging mode N” state, the charge accumulated in the shunt capacitor CP through the resonance of the shunt capacitor CP with the inductance L of the inductive load LD becomes the resonant current and is discharged to the inductive load LD. In addition, the energy consumed by the resistance R of the inductive load LD and the energy consumed by the electromagnetic induction of the inductive load LD are compensated by the supply current continuing to flow. With regard to the resonant current, the current flowing from the shunt capacitor CP flows to the inductive load LD and returns to the shunt capacitor CP. When the electric charge accumulated in the shunt capacitor CP has been discharged and is gone, the voltage both of ends of the shunt capacitor CP becomes roughly zero [V], and the resonant current ceases flowing to the shunt capacitor CP.

6) Accordingly, the “parallel conduction mode N” shown in FIG. 14F and the state shown in section (f) of FIG. 15 are achieved. In the “parallel conduction mode N” state, the resonant current flows as indicated by the arrow shown in FIG. 14F. In addition, the energy consumed by the resistance R of the inductive load LD and the energy consumed by the electromagnetic induction of the inductive load LD are compensated by the supply current continuing to flow. The resonant current flowing from the inductive load LD flows along a first path flowing to the inductive load LD passing through the second alternating-current terminal AC2, the diode DSW3 of the third reverse-conductive semiconductor switch SW3 in an off state, the positive pole terminal DCP, the self-extinguishing device SSW1 of the first reverse-conductive semiconductor switch SW1 in an on state and the first alternating-current terminal AC1, and a second path flowing to the inductive load LD passing through the second alternating-current terminal AC2, the self-extinguishing element SSW4 of the fourth reverse-conductive semiconductor switch SW4 in an on state, the negative pole terminal DCN, the diode DSW2 of the second reverse-conductive semiconductor switch SW2 in an off state and the first alternating-current terminal AC1.

7) When the control circuit 20 next brings the second reverse-conductive semiconductor switch SW2 and the third reverse-conductive semiconductor switch SW3 into an on state and the first reverse-conductive semiconductor switch SW1 and the fourth reverse-conductive semiconductor switch SW4 into an off state, the “charging mode P” shown in FIG. 14A and the state shown in section (a) of FIG. 15 are again attained.

The power inverter 1B in a steady state repeats the above-described operations and can provide alternating power to the inductive load LD.

The shunt capacitor CP needs to be a non-polarized capacitor that can be used in an alternating-current circuit. In addition, taking the maximum value of the frequency of the alternating power sent to the inductive load LD to be fmax, the capacitance of the shunt capacitor CP to be (CP) and the inductance of the inductance L of the inductive load LD to be (L), these must satisfy the following equation (3).

fmax≦1/(2·π·√(L·CP)) (3)

Suppose the above equation (3) is not satisfied. The resonance period “1/fres” of the shunt capacitor CP and the inductance L of the inductive load LD becomes larger than the switching frequency “1/fsw”, and as long as the charge accumulated in the shunt capacitor CP does not disappear, the on and off states of the reverse-conductive semiconductor switches SW1 to SW4 are changed through switching. At this time, the worry arises that the shunt capacitor CP could short circuit because of the switching, resulting in the reverse-conductive semiconductor switches SW1 to SW4 causing short-circuit damage. Accordingly, the above equation (3) must be satisfied. In other words, the control circuit 20 needs to control the on and off states of the reverse-conductive semiconductor switches SW1 to SW4 at a switching frequency fsw that is no more than the resonant frequency fres determined by the capacitance (CP) of the shunt capacitor CP and the inductance L of the inductive load LD.

Parts (1) through (5) of FIG. 15 show the voltage waveforms or the current waveforms of the s of the power inverter 1B shown in FIG. 13. These are waveforms assuming the capacitance C of the shunt capacitor CP is 200 μF, the inductance of the inductance L of the inductive load LD is 10.5 μH, the resistance of the resistance R of the inductive load LD is 0.04Ω, the inductance of the direct-current reactor Ldc is 1 mH, the output voltage of the direct-current power supply 2 is 1,000 V and the switching frequency fres of the control circuit 20 is 3,000 Hz.

Part (1) of FIG. 15 shows the voltage Vload impressed on the inductive load LD, in other words the output voltage. In addition, part (2) of FIG. 15 shows the current Iload flowing to the inductive load LD, in other words the output current. Part (3) of FIG. 15 shows the current Isw2 flowing to the reverse-conductive semiconductor switch SW2, and part (4) of FIG. 15 shows the current Icp flowing to the shunt capacitor CP.

As shown in part (1) of FIG. 15, a pulse voltage in which positive and negative alternate occurs in the voltage Vload impressed on the inductive load LD because of the resonance between the shunt capacitor C and the inductance L included in the inductive load LD, and switching. In addition, as shown in part (2) of FIG. 15, the current Iload flowing to the inductive load LD creates an alternating current whose phase lags the output voltage Vload because of the inductance L. Furthermore, as shown in parts (3) and (4) of FIG. 15, the electric current flowing to the reverse-conductive semiconductor switch SW2 is relatively small, and times when a large current flows are limited to the parallel conduction mode P and the parallel conduction mode N. This is because originally most of the current to be supplied flowing to the reverse-conductive semiconductor switch SW2 becomes only supply current because the resonant current is circulating between the inductive load LD and the shunt capacitor CP.

By comparing part (3) of FIG. 15 and part (3) of FIG. 4, it can be seen that in the charging mode P and the charging mode N, and in the discharging mode P and the discharging mode N, of the power inverter 1B according to the second embodiment of the present invention, the current flowing to the various reverse-conductive semiconductor switches is considerably smaller than the current flowing to the various reverse-conductive semiconductor switches in those modes in the power inverter disclosed in Patent Literature 1. On the other hand, the current does not become smaller in the parallel conduction mode P and the parallel conduction mode N of the power inverter 1B according to the second embodiment of the present invention. This is because in the power inverter 1B according to the second embodiment of the present invention, the shunt capacitor CP and the inductance L of the inductive load LD resonate, the electric charge accumulated in the shunt capacitor CP is discharged each half-period of switching, and the voltage between both of ends of the shunt capacitor CP becomes roughly zero [V]. This is because if there is no fluctuation in the charge accumulated in the shunt capacitor CP (in other words, in the parallel conduction mode P and the parallel conduction mode N states), no current flows to the shunt capacitor CP.

With the load parallel capacitor-type of power inverter 1B as described by the second embodiment of the present invention above, the power inverter 1B can make it so that the resonant current virtually does not pass through the reverse-conductive semiconductor switches SW1 to SW4 while the shunt capacitor CP is charging or discharging, by using only the shunt capacitor CP and not using the resonant capacitor CM and connecting the shunt capacitor CP in parallel with the inductive load LD.

### Embodiment 3

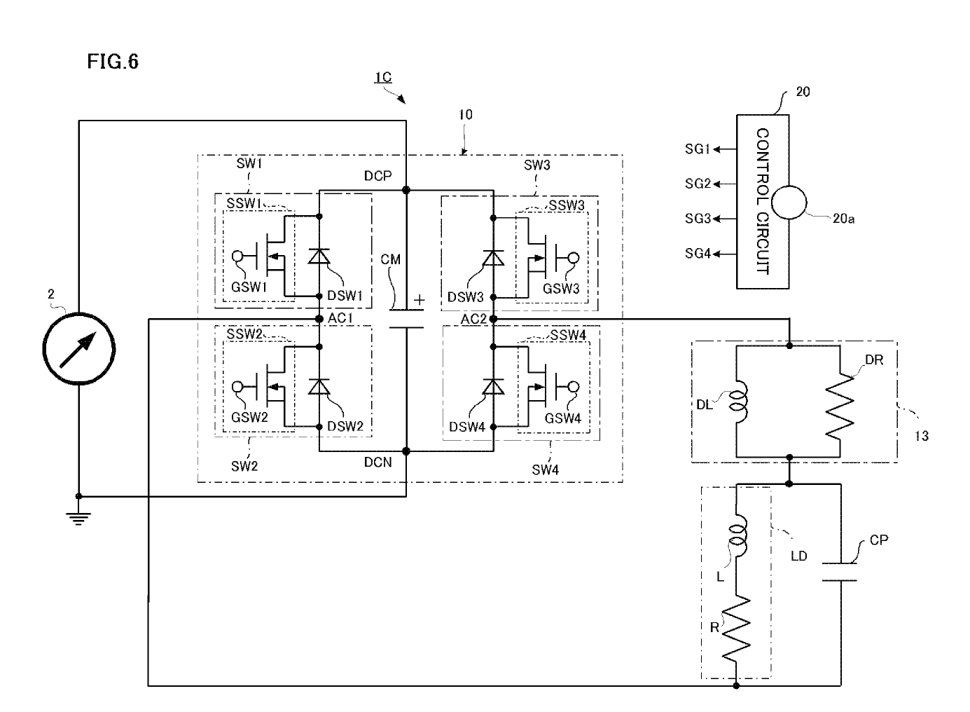

FIG. 6 is a block circuit diagram showing the composition of a power inverter 1C (hereafter, referred to as an oscillation suppression circuit added type) according to a third embodiment of the present invention. In the power inverter 1C according to the third embodiment of the present invention, constituent elements, members and processes that are the same as in the power inverter 1A according to the first embodiment of the present invention are labeled with the same symbols, and redundant explanation of such is omitted.

The power inverter 1C according to this embodiment is connected with an oscillation suppression circuit for suppressing the generation of parasitic oscillations added to the power inverter 1A according to the first embodiment of the present invention. More specifically, the power inverter 1C according to the present embodiment has an oscillation suppression circuit 13 connected between the second alternating-current terminal AC2 of the full-bridge circuit 10 and the inductive load LD in the power inverter 1A according to the first embodiment of the present invention.

In the power inverter 1A according to the first embodiment of the present invention, it is necessary for the resonant capacitor CM and the shunt capacitor CP to resonate as a composite capacitor C at a target frequency with the inductance L of the inductive load LD in order to mitigate the effects of parasitic inductance between the resonant capacitor CM and the shunt capacitor CP. Parasitic inductance causes resonances at a different frequency from the target frequency with each of the capacitors. When switching of the reverse-conductive semiconductor switches is accomplished in this state in which resonance (hereafter referred to as parasitic oscillation) is generated at a different frequency, there are concerns that problems could arise such as soft switching not being realized.

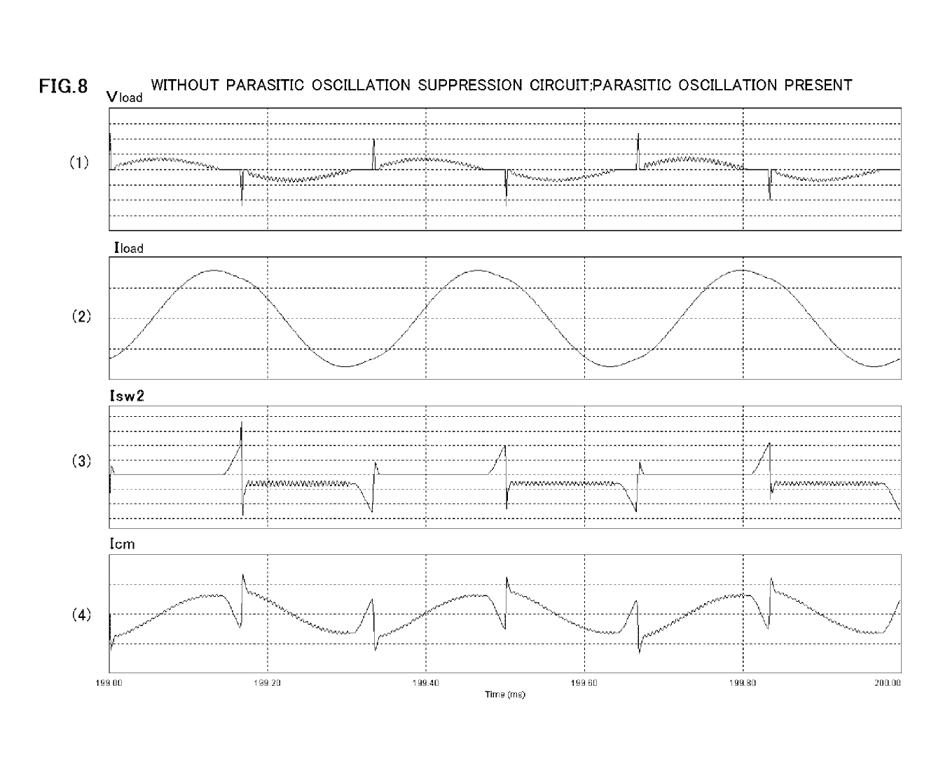

Parts (1) through (4) of FIG. 8 show the voltage waveforms or the current waveforms of various components when parasitic inductance exists in the power inverter 1A according to the first embodiment of the present invention. More specifically, part (1) of FIG. 8 shows the voltage Vload impressed on the inductive load LD, part (2) of FIG. 8 shows the current Iload flowing to the inductive load LD, part (3) of FIG. 8 shows the current Isw2 flowing to the reverse-conductive semiconductor switch SW2 and part (4) of FIG. 8 shows the Icm flowing to the resonant capacitor CM. As shown in parts (1), (3) and (4) of FIG. 8, during switching of the reverse-conductive semiconductor switch SW2, surge voltage and surge current are generated. When the surge voltage and surge current exceed the ratings of the reverse-conductive semiconductor switches and the respective capacitors, the concern is that this could be a cause of the reverse-conductive semiconductor switches and the respective capacitors being destroyed and lifespan being extremely shortened.

In many cases, parasitic oscillation can be largely avoided by shortening the physical distance between the resonant capacitor CM and the shunt capacitor CP, or by connecting to the wiring a device having a small parasitic inductance, such as a bus-bar. However, for example in the state of the power inverter 1A immediately after manufacturing, even if parasitic oscillation is not generated there is concern that parasitic oscillation could occur after time has elapsed following the start of use of the power inverter 1A due to deterioration with age. Hence, it is preferable to respond in advance by adding an oscillation suppression circuit 13 so as to sufficiently dampen parasitic oscillation at the time of switching the reverse-conductive semiconductor switches.

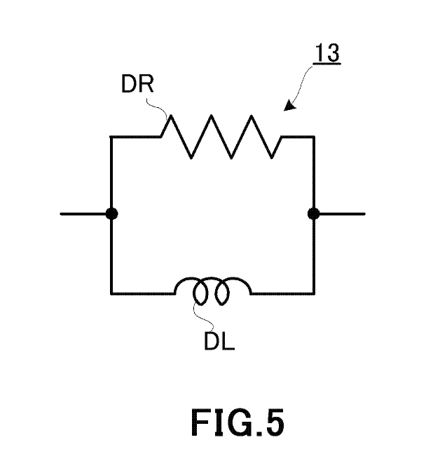

FIG. 5 shows one example of the oscillation suppression circuit 13, and FIG. 6 shows an example of the composition when the oscillation suppression circuit 13 is applied in a case in which parasitic inductance is present in the power inverter 1A according to the first embodiment of the present invention. More specifically, in the oscillation suppression circuit 13 shown in FIG. 5, an inductor DL and a resistor DR are connected in parallel. In FIG. 6, the oscillation suppression circuit 13 is connected between the second alternating-current terminal AC2 of the full-bridge circuit 10 and the inductive load LD, near the shunt capacitor CP.

In addition, as necessary the parasitic oscillation may be dampened by connecting more than one oscillation suppression circuit 13 between the resonant capacitor CM and the shunt capacitor CP. Furthermore, the oscillation suppression circuit 13 may be connected in series with the resonant capacitor CM, near the resonant capacitor CM.

The oscillation suppression circuit 13 must dampen the parasitic oscillation current as this flows to the resistor DR, while the current that is to flow to the inductive load LD flows to the inductor DL and is not dampened. The resistance value of the resistor DR and the inductance (DL) of the inductor DL that comprise the oscillation suppression circuit 13 can be found as follows.

When the oscillation frequency of the parasitic oscillation is fstray, the absolute value of the inductance of the inductor DL becomes 2·π·fstray·(DL). Taking (DR) to be the inductance of the resistor DR in the oscillation suppression circuit 13, the conditions that should be satisfied by the oscillation suppression circuit 13 are expressed by formulas (4) and (5) below.

2·π·fstray·(DL)>>(DR) (4)

2·π·fmax·(DL)<<(DR) (5)

When the above formula (4) is not satisfied, most of the parasitic oscillation current flows to the inductor DL, so parasitic oscillation continues without being dampened, and moreover unnecessary parasitic oscillation is evoked. In addition, when the above formula (5) is not satisfied, the power of the target frequency that should be sent to the inductive load LD is dampened by the resistor DR. Accordingly, the resistance of the resistor DR and the inductance (DL) of the inductor DL of the oscillation suppression circuit 13 are found so that the above formulas (4) and (5) are both satisfied.

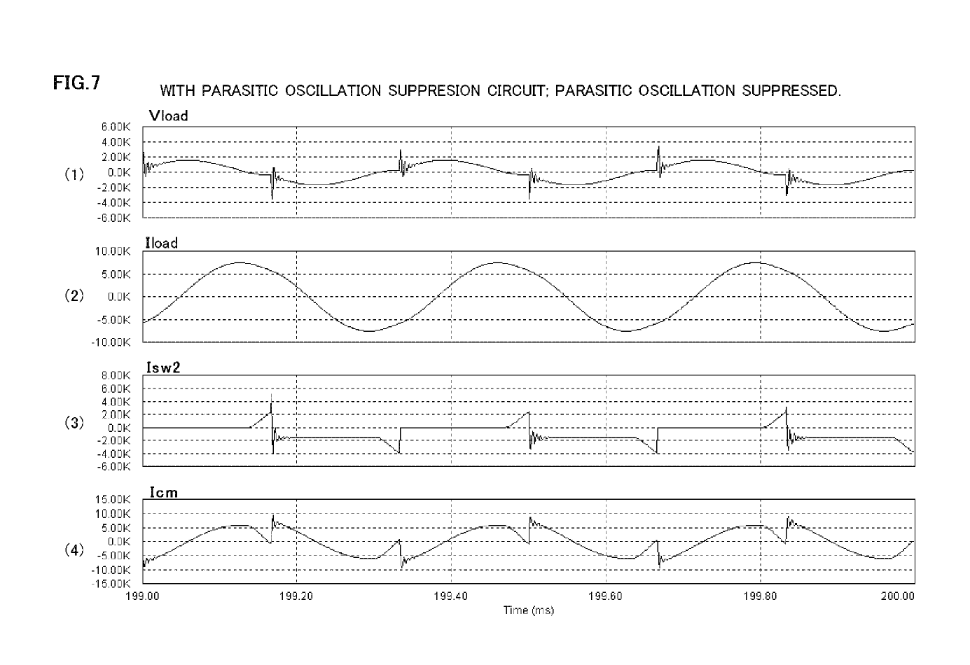

Parts (1) through (4) of FIG. 7 show the voltage waveforms or the current waveforms of various components when the oscillation suppression circuit 13 based on the above method is connected a case in which parasitic inductance exists in the power inverter 1A according to the first embodiment of the present invention. More specifically, part (1) of FIG. 7 shows the voltage Vload impressed on the inductive load LD, part (2) of FIG. 7 shows the current Iload flowing to the inductive load LD, part (3) of FIG. 7 shows the current Isw2 flowing to the reverse-conductive semiconductor switch SW2 and part (4) of FIG. 7 shows the Icm flowing to the resonant capacitor CM. As can be seen by comparing parts (1) through (4) of FIG. 7 and parts (1) through (4) of FIG. 8, by connecting the oscillation suppression circuit 13, surge voltage and surge current are controlled and parasitic oscillation is dampened when switching the reverse-conductive semiconductor switch SW2.

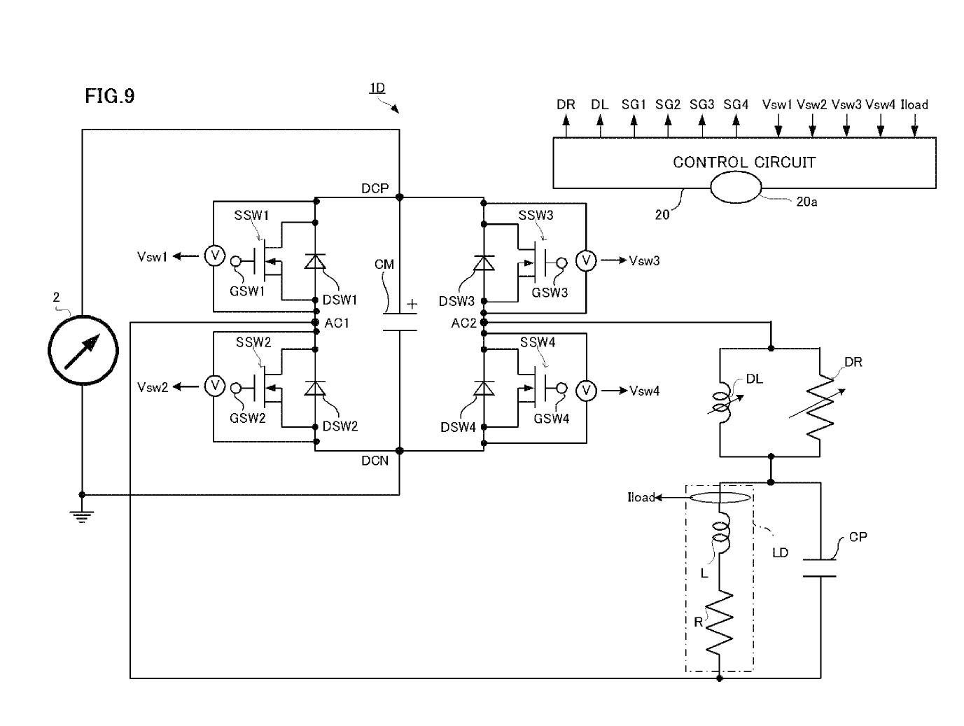

The inductance (DL) of the inductor DL and the impedance (DR) of the resistor DR that comprise the oscillation suppression circuit 13 may be automatically set so as to dampen parasitic oscillation. For example, the inductance (DL) of the inductor DL and the impedance (DR) of the resistor DR of the oscillation suppression circuit 13 can be variably composed from the control circuit 20, as shown in FIG. 9. In addition, an ammeter IPload that detects the load current Iload is installed in the inductive load LD and voltmeters Vsw1 to Vsw4 are connected to the reverse-conductive semiconductor switches SW1 to SW4.

The control circuit 20 is provided with a processor or the like into which the measured value Iload of the ammeter IPload and the measured values Vsw1 to Vsw4 of the voltmeters are input and the circuit periodically monitors for the generation of parasitic oscillation. When parasitic oscillation is detected, the control circuit 20 analyzes the frequency thereof through a FFT (Fast Fourier Transform) or the like, and through computational processing finds and automatically sets the inductance (DL) of the inductor DL and the impedance (DR) of the resistor DR in order to dampen the parasitic oscillation. With the above-described composition, the parasitic oscillation can be automatically dampened even when parasitic oscillation is generated due to changes with the lapse of time.

The power inverter 1C according to the third embodiment of the present invention was described in a configuration in which a parasitic oscillation suppression circuit 13 is connected in the power inverter 1A according to the first embodiment of the present invention, but a configuration in which the parasitic oscillation suppression circuit 13 is connected to the power inverter 1B according to the second embodiment of the present invention would also be fine, and it would be possible to obtain the same functions and effects as above.

The above-described embodiments are intended to be illustrative and not limiting, for various variations and applications are possible.

For example, it is possible to use as the self-extinguishing devices that comprise the reverse-conductive semiconductor switches transistors, or field effect transistors (FET), insulated gate bipolar transistors (IGBT), injection-enhanced gate transistors (IEGT), gate turn-off thyristors (GTO thyristors) or gate commutated turn-off thyristors (GCT thyristors).

In addition, the reverse-conductive semiconductor switches may not have a reverse blocking ability, or in other words may be capable of reverse conduction, and may be circuits in which the self-extinguishing devices and the devices having a rectifying action are connected in parallel with their forward directions reversed from each other, or a semiconductor device equivalent to this circuit. In the future, even when new circuits functions equivalent to reverse-conductive semiconductor switches are developed, it will be possible to easily use the power inverter according to the present invention.

In addition, when the self-extinguishing device is a field-effect transistor (FET), or when the when the reverse-conductive semiconductor switch is a metal oxide semiconductor field effect transistor (MOSFET) with a built-in parasitic diode, the control circuit becomes a synchronous rectification method by accomplishing control so that the self-extinguishing device is brought into an on state at the conduction time of the device having the rectifying function, so it is possible to reduce conduction loss at the conduction time of the device having the rectifying function.

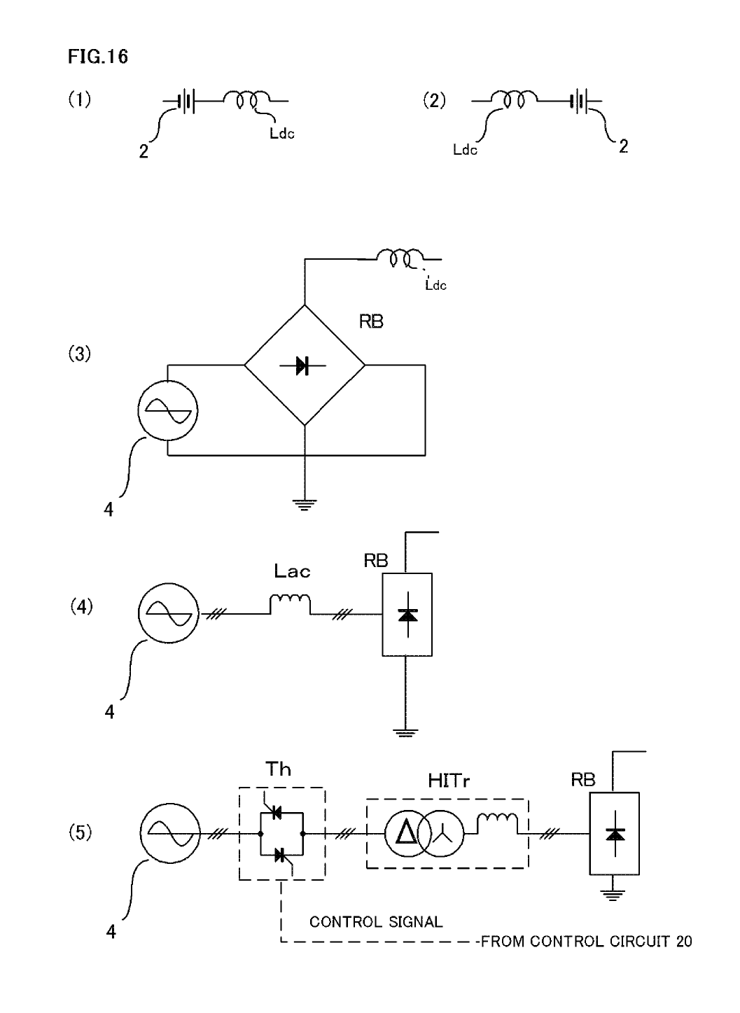

In addition, the direct-current current supply 3 can have various compositions, as shown in parts (1) through (5) of FIG. 16. Parts (1) and (2) of FIG. 16 show methods of making the direct-current voltage supply 2 a direct-current current supply. More specifically, part (1) of FIG. 16 shows a power supply in which the direct-current reactor Ldc is connected in series to the positive pole terminal of the direct-current voltage supply 2. Part (2) of FIG. 16 shows a power supply in which the direct current-reactor Ldc is connected in series with the negative pole terminal of the direct current voltage supply 2.

Parts (3) and (4) of FIG. 16 show methods for making alternating-current power supplies into direct-current power supplies. More specifically, part (3) of FIG. 16 shows a power supply composed of the alternating-current power supply 4, the rectifying circuit RB and the direct-current reactor Ldc connected to the direct-current terminal of the rectifying circuit RB. Part (4) of FIG. 16 shows a power supply composed of the alternating-current power supply 4, the rectifying circuit RB and the alternating-current reactor Lac connected between the alternating-current power supply 4 and the alternating-current terminal of the rectifying circuit RB.

Part (5) of FIG. 16 shows a method of adjusting the voltage of the alternating-current power supplied to inductive load LD. More specifically, part (5) of FIG. 16 is composed of the alternating-current power supply 4, a thyristor alternating-current power regulator Th connected to one terminal of the alternating-current power supply 4, a high impedance transformer HITr, the first side of which is connected to the other terminal of the thyristor alternating-current power regulator Th, and the rectifying circuit RB connected to the second side of the high impedance transformer HITr. The control circuit 20 sends control signals to the thyristor alternating-current power regulator Th and can adjust the alternating-current voltage supplied to the inductive load.

The above-described numerical values, circuit compositions, operations and processes are exemplary and not limiting. In addition, it is not necessary to provide the entire composition described in the above embodiments, and partial compositions may be combined if the anticipated object can be achieved.

The present invention is based on PCT/JP2008/069484 filed on Oct. 27, 2008, and U.S. 61/160,315, filed on Mar. 15, 2009, and the specification, scope of claims and drawings of PCT/JP2008/069484 and U.S. 61/160,315 are incorporated by reference herein.

### EXPLANATION OF SYMBOLS

1A, 1B, 1C, 1D power inverter
2 direct-current voltage supply
3 direct-current current supply
4 alternating-current power supply
10 full-bridge circuit
13 oscillation suppression circuit
20 control circuit
20a outside interface
Lac alternating-current reactor
Ldc direct-current reactor
CM resonant capacitor
CP shunt capacitor
SW1, SW2, SW3, SW4 reverse-conductive semiconductor switch
SSW1, SSW2, SSW3, SSW4 self-extinguishing device
GSW1, GSW2, GSW3, GSW4 self-extinguishing device gate
DSW1, DSW2, DSW3, DSW4 diode
SG1, SG2, SG3, SG4 control signal
LD inductive load
L inductance of the inductive load
R resistance of the inductive load
DCP positive pole terminal
DCN negative pole terminal
AC1 first alternating-current terminal
AC2 second alternating-current terminal
DL inductor
DR resistor
RB rectifying circuit
Th thyristor alternating-current power regulator
HITr high impedance transformer
Vsw1, Vsw2, Vsw3, Vsw4 voltmeter
IPload ammeter

1. A power inverter, having as an reverse-conductive semiconductor switch a circuit in which a self-extinguishing device that can switch between a conductive state and a blocked state of the device through signals obtained from outside, and a device having a rectifying action, are connected with forward directions mutually inverted from each other, or a semiconductor equivalent to said circuit,
provided with a full-bridge circuit having a first reverse-conductive semiconductor switch, a second reverse-conductive semiconductor switch the positive pole of which is connected to the negative pole of the first reverse-conductive semiconductor switch, a third reverse-conductive semiconductor switch the positive pole of which is connected to the positive pole of the first reverse-conductive semiconductor switch, a fourth reverse-conductive semiconductor switch the positive pole of which is connected to the negative pole of the third reverse-conductive semiconductor switch and the negative pole of which is connected to the negative pole of the second reverse-conductive semiconductor switch, a first alternating-current output terminal connected to the connection point of the first reverse-conductive semiconductor switch and the second reverse-conductive semiconductor switch, a second alternating-current output terminal connected to the connection point of the third reverse-conductive semiconductor switch and the fourth reverse-conductive semiconductor switch, a positive pole terminal connected to the positive pole of the third reverse-conductive semiconductor switch and the first reverse-conductive semiconductor switch, and a negative pole terminal connected to the negative pole of the second reverse-conductive semiconductor switch and the negative pole of the fourth reverse-conductive semiconductor switch;
a first capacitor connected between the first alternating-current output terminal and the second alternating-current output terminal; and
a control circuit;
wherein a direct-current power supply is connected between the positive pole terminal and the negative pole terminal;
an inductive load is connected between the first alternating-current output terminal and the second alternating-current output terminal;
the control circuit controls the on/off state of the reverse-conductive semiconductor switches so that the second reverse-conductive semiconductor switch and the third reverse-conductive semiconductor switch are brought into an off state when the first reverse-conductive semiconductor switch and the fourth reverse-conductive semiconductor switch are in an on state; and
so that the second reverse-conductive semiconductor switch and the third reverse-conductive semiconductor switch are brought into an on state when the first reverse-conductive semiconductor switch and the fourth reverse-conductive semiconductor switch are in an off state; and
the control circuit further controls the on/off states of the reverse-conductive semiconductor switches at a switching frequency that is no more than the resonant frequency determined by the capacitance of the first capacitor and the inductance of the inductive load.

2. The power inverter according to claim 1, further comprising a second capacitor connected between the positive pole terminal and the negative pole terminal of the full-bridge circuit;
wherein the control circuit controls the on/off state of the reverse-conductive semiconductor switches at a switching frequency that is no more than the resonant frequency determined by the inductance of the inductive load and the composite capacitance of the capacitance of the first capacitor and the capacitance of the second capacitor.

3. The power inverter according to claim 2, wherein the capacitance of the first capacitor is larger than the capacitance of the second capacitor.

4. The power inverter according to claim 2, wherein the first capacitor is composed of a non-polarized capacitor and the second capacitor is composed of a polarized capacitor.

5. The power inverter according to claim 1, wherein the self-extinguishing device is a transistor, a field effect transistor (FET), an insulated gate bipolar transistor (IGBT), an injection-enhanced gate transistor (IEGT), a gate turn-off thyristor (GTO thyristor), or a gate current turn-off thyristor (GCT thyristor).

6. The power inverter according to claim 1, wherein the reverse-conductive semiconductor switch is a metal oxide semiconductor field effect transistor (MOSFET) with a built-in parasitic diode.

7. The power inverter according to claim 1, wherein when the self-extinguishing device is a field effect transistor (FET) or when the reverse-conductive semiconductor switch is a metal oxide semiconductor field effect transistor (MOSFET) with a built-in parasitic diode, the control circuit accomplishes control so that the self-extinguishing device is brought into a conductive state when the device having a rectifying action is conducting.

8. The power inverter according to claim 1, wherein the direct-current power supply is composed of a direct-current voltage supply and a direct-current reactor connected to the direct-current voltage supply.

9. The power inverter according to claim 1, wherein the direct-current power supply is composed of an alternating-current power supply, a rectifying circuit and an alternating-current reactor connected between the alternating-current power supply and the alternating-current terminal of the rectifying circuit.

10. The power inverter according to claim 1, wherein the direct-current power supply is composed of the alternating-current power supply, a thyristor alternating-current power regulator one end of which is connected to the alternating-current power supply, a high impedance transformer the primary side of which is connected to the other end of the thyristor alternating-current power regulator, and a rectifying circuit the alternating-current terminal of which is connected to the secondary side of the high impedance transformer, wherein the control circuit sends control signals to the thyristor alternating-current power regulator and adjusts the volume of the alternating-current power supplied to the inductive load.

11. The power inverter according to claim 1, wherein one or more parasitic oscillation suppression circuits is connected.

12. The power inverter according to claim 1, wherein a resonant reactor is connected to the primary winding terminal with the inductive load as a current transformer for retrieving the alternating-current power isolated from the secondary winding terminal to the primary winding terminal.

13. The power inverter according to claim 1, wherein the inductive load is composed of an alternating-current electric motor and functions as an alternating-current electric motor control system for accomplishing control of the alternating-current electric motor.

14. The power inverter according to claim 1, wherein the inductive load is composed of an induction heating coil for heating an object through electromagnetic induction, and functions as an induction heating system for accomplishing control of induction heating of the object.
